(19) United States
(12) Patent Application Publication
(10) Pub. No.: US 2026/0072251 A1
(43) Pub. Date: Mar. 12, 2026

(54) IMAGING OPTICAL LENS SYSTEM, IMAGING APPARATUS AND ELECTRONIC DEVICE

(71) Applicant: LARGAN PRECISION CO., LTD., Taichung City (TW)

(72) Inventors: Min-En CHOU, Taichung City (TW); Guan-Jr LIAO, Taichung City (TW)

(21) Appl. No.: 19/317,355

(22) Filed: Sep. 3, 2025

(30) Foreign Application Priority Data
Sep. 12, 2024 (TW) 113134637

(51) Int. Cl. G02B 13/00; G02B 9/64

(52) U.S. Cl. CPC G02B 13/0045; G02B 9/64

(57) ABSTRACT

An imaging optical lens system includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. The first lens element has negative refractive power. The second lens element has negative refractive power. The image-side surface of the second lens element is concave in a paraxial region thereof. The object-side surface of the fourth lens element is concave in a paraxial region thereof. The sixth lens element has negative refractive power.

### RELATED APPLICATIONS

This application claims priority to Taiwan Application Serial Number 133134637, filed Sep. 12, 2024, which is herein incorporated by reference.

### BACKGROUND

### Technical Field

The present disclosure relates to an imaging optical lens system and an imaging apparatus. More particularly, the present disclosure relates to an imaging optical lens system and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of electronic devices equipped with optical lens assemblies increase and there is a wide variety of requirements for optical lens assemblies. However, in a conventional optical lens assembly, it is hard to balance among image quality, sensitivity, aperture size, volume or field of view. Thus, there is a demand for an image capturing system lens assembly that meets the aforementioned needs.

### SUMMARY

According to one aspect of the present disclosure, an imaging optical lens system includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. Preferably, the first lens element has negative refractive power. Preferably, the second lens element has negative refractive power. Preferably, the image-side surface of the second lens element is concave in a paraxial region thereof. Preferably, the object-side surface of the fourth lens element is concave in a paraxial region thereof. Preferably, the object-side surface of the fifth lens element is convex in a paraxial region thereof. Preferably, the sixth lens element has negative refractive power. Preferably, the image-side surface of the eighth lens element includes at least one inflection point. When a focal length of the imaging optical lens system is f, a composite focal length of the seventh lens element and the eighth lens element is f78, a curvature radius of the image-side surface of the first lens element is R2, and a curvature radius of the image-side surface of the second lens element is R4, the following conditions are preferably satisfied: −1.20<f/f78<0.10; and 0.10<|R2/R4|<10.00.

According to one aspect of the present disclosure, an imaging optical lens system includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. Preferably, the first lens element has negative refractive power. Preferably, the second lens element has negative refractive power. Preferably, the object-side surface of the fourth lens element is concave in a paraxial region thereof. Preferably, the sixth lens element has negative refractive power. When a focal length of the first lens element is f1, a focal length of the seventh lens element is f7, and an Abbe number of the eighth lens element is V8, the following conditions are preferably satisfied: 0.00<|f1/f7|<0.60; and 5.0<V8<30.0.

According to one aspect of the present disclosure, an imaging optical lens system includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side. Preferably, the first lens element has negative refractive power. Preferably, the second lens element has negative refractive power. Preferably, the object-side surface of the fourth lens element is concave in a paraxial region thereof. Preferably, the sixth lens element has negative refractive power. Preferably, the image-side surface of the eighth lens element includes at least one inflection point. When an axial distance between the object-side surface of the first lens element and the image-side surface of the eighth lens element is TD, a focal length of the imaging optical lens system is f, and a composite focal length of the seventh lens element and the eighth lens element is f78, the following conditions are preferably satisfied: 2.00<TD/f<5.00; and −0.80<f/f78<0.00.

According to one aspect of the present disclosure, an imaging apparatus includes the imaging optical lens system of the aforementioned aspect and an image sensor, wherein the image sensor is disposed on an image surface of the imaging optical lens system.

According to one aspect of the present disclosure, an electronic device includes the imaging apparatus of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging apparatus according to the 1st embodiment of the present disclosure.

FIG. 1B shows spherical aberration curves, astigmatic field curves and a distortion curve of the imaging apparatus according to the 1st embodiment.

FIG. 2A is a schematic view of an imaging apparatus according to the 2nd embodiment of the present disclosure.

FIG. 2B shows spherical aberration curves, astigmatic field curves and a distortion curve of the imaging apparatus according to the 2nd embodiment.

FIG. 3A is a schematic view of an imaging apparatus according to the 3rd embodiment of the present disclosure.

FIG. 3B shows spherical aberration curves, astigmatic field curves and a distortion curve of the imaging apparatus according to the 3rd embodiment.

FIG. 4A is a schematic view of an imaging apparatus according to the 4th embodiment of the present disclosure.

FIG. 4B shows spherical aberration curves, astigmatic field curves and a distortion curve of the imaging apparatus according to the 4th embodiment.

FIG. 5A is a schematic view of an imaging apparatus according to the 5th embodiment of the present disclosure.

FIG. 5B shows spherical aberration curves, astigmatic field curves and a distortion curve of the imaging apparatus according to the 5th embodiment.

FIG. 6A is a schematic view of an imaging apparatus according to the 6th embodiment of the present disclosure.

FIG. 6B shows spherical aberration curves, astigmatic field curves and a distortion curve of the imaging apparatus according to the 6th embodiment.

FIG. 7A is a schematic view of an imaging apparatus according to the 7th embodiment of the present disclosure.

FIG. 7B shows spherical aberration curves, astigmatic field curves and a distortion curve of the imaging apparatus according to the 7th embodiment.

FIG. 8A is a schematic view of an imaging apparatus according to the 8th embodiment of the present disclosure.

FIG. 8B shows spherical aberration curves, astigmatic field curves and a distortion curve of the imaging apparatus according to the 8th embodiment.

FIG. 9A is a schematic view of an imaging apparatus according to the 9th embodiment of the present disclosure.

FIG. 9B shows spherical aberration curves, astigmatic field curves and a distortion curve of the imaging apparatus according to the 9th embodiment.

FIG. 10A is a schematic view of an imaging apparatus according to the 10th embodiment of the present disclosure.

FIG. 10B shows spherical aberration curves, astigmatic field curves and a distortion curve of the imaging apparatus according to the 10th embodiment.

FIG. 11A is a schematic view of an imaging apparatus according to the 11th embodiment of the present disclosure.

FIG. 11B shows spherical aberration curves, astigmatic field curves and a distortion curve of the imaging apparatus according to the 11th embodiment.

FIG. 12A is a schematic view of an imaging apparatus according to the 12th embodiment of the present disclosure.

FIG. 12B shows spherical aberration curves, astigmatic field curves and a distortion curve of the imaging apparatus according to the 12th embodiment.

FIG. 13 is a schematic view of the inflection points and the critical points of each lens element according to the 1st embodiment.

FIG. 14 is a schematic view of an imaging apparatus according to the 13th embodiment of the present disclosure.

FIG. 15A is a schematic view of one side of an electronic device according to the 14th embodiment of the present disclosure.

FIG. 15B is a schematic view of another side of the electronic device of FIG. 15A.

FIG. 15C is a system schematic view of the electronic device of FIG. 15A.

FIG. 16 is a schematic view of one side of an electronic device according to the 15th embodiment of the present disclosure.

FIG. 17 is a schematic view of one side of an electronic device according to the 16th embodiment of the present disclosure.

FIG. 18A is a schematic view of one side of an electronic device according to the 17th embodiment of the present disclosure.

FIG. 18B is a schematic view of another side of the electronic device according to the 17th embodiment of FIG. 18A.

FIG. 19 is a schematic view of one side of an electronic device according to the 18th embodiment of the present disclosure.

### DETAILED DESCRIPTION

An imaging optical lens system includes eight lens elements, which are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface towards the object side and an image-side surface towards the image side.

The first lens element can have negative refractive power, which is favorable for enlarging the field of view.

The second lens element can have negative refractive power, which is favorable for correcting spherical aberration by cooperating with the third lens element. The image-side surface of the second lens element can be concave in a paraxial region thereof, so that it is favorable for correcting astigmatism of the imaging optical lens system so as to balancing the image quality of the center and peripheral region of the image. The object-side surface of the second lens element can include at least one inflection point, so that it is favorable for correcting off-axis aberration generated by large field of view.

The third lens element can have positive refractive power, so that it is favorable for compressing the volume of the object side of the imaging optical lens system.

The object-side surface of the fourth lens element is concave in a paraxial region thereof, so that it is favorable for moderating the angle difference between incident light and the optical axis by adjusting the surface shape and refractive power of the fourth lens element. The image-side surface of the fourth lens element can be convex in a paraxial region thereof, so that it is favorable for reducing the total internal reflection by adjusting the exiting direction of light from the fourth lens element.

The fifth lens element can have positive refractive power, which is favorable for sharing the light gathering ability of the imaging optical lens system. The object-side surface of the fifth lens element can be convex in a paraxial region thereof, so that it is favorable for enhancing the positive refractive power of the fifth lens element by adjusting the surface shape of the fifth lens element.

The sixth lens element can have negative refractive power, so that it is favorable for balancing aberration caused by reducing volume of the imaging optical lens system.

The image-side surface of the eighth lens element can include at least one inflection point. Therefore, it is favorable for correcting image curvature and distortion, and also reducing the total track length of the imaging optical lens system.

A central thickness of the third lens element can be a maximum among central thicknesses of the eight lens elements. Therefore, it is favorable for providing sufficient light converging ability for the imaging optical lens system.

At least one of the third lens element, the fourth lens element and the fifth lens element can be made of glass material. Therefore, it is favorable for reducing the decreasing of the image quality caused by the environment temperature variation.

When a focal length of the imaging optical lens system is f, and a composite focal length of the seventh lens element and the eighth lens element is f78, the following condition is satisfied: −1.20<f/f78<0.10. Therefore, it is favorable for correcting spherical aberration and astigmatism and balancing the distribution of refractive power on the image side of the imaging optical lens system so as to enhancing the image quality. Further, the following condition can be satisfied: −0.80<f/f78<0.00. Further, the following condition can be satisfied: −0.60<f/f78<−0.05. Further, the following condition can be satisfied: −0.43≤f/f78≤−0.10.

When a curvature radius of the image-side surface of the first lens element is R2, and a curvature radius of the image-side surface of the second lens element is R4, the following condition is satisfied: 0.10<|R2/R4|<10.00. Therefore, it is favorable for adjusting traveling direction of light so as to enlarge field of view. Further, the following condition can be satisfied: 0.15<|R2/R4|<4.00. Further, the following condition can be satisfied: 0.20<|R2/R4|<2.00. Further, the following condition can be satisfied: 0.30<|R2/R4|<1.00. Further, the following condition can be satisfied: 0.53≤|R2/R4|≤0.69.

When a focal length of the first lens element is f1, and a focal length of the seventh lens element is f7, the following condition is satisfied: 0.00<|f1/f7|<0.60. Therefore, it is favorable for enhancing the image quality by balancing the distribution of the refractive power of the imaging optical lens system. Further, the following condition can be satisfied: 0.00<|f1/f7|<0.40. Further, the following condition can be satisfied: 0.00<|f1/f7|<0.30. Further, the following condition can be satisfied: 0.01≤|f1/f7|≤0.22.

When an Abbe number of the eighth lens element is V8, the following condition is satisfied: 5.0<V8<30.0. Therefore, it is favorable for obtaining the balance between chromatic aberration and the back focal length by adjusting the Abbe number of the eighth lens element. Further, the following condition can be satisfied: 10.0<V8<28.0. Further, the following condition can be satisfied: 18.2≤V8≤25.6.

When an axial distance between the object-side surface of the first lens element and the image-side surface of the eighth lens element is TD, and the focal length of the imaging optical lens system is f, the following condition is satisfied: 2.00<TD/f<5.00. Therefore, it is favorable for balancing the total track length and field of view of the imaging optical lens system so as to form the wild angle characteristic. Further, the following condition can be satisfied: 2.50<TD/f<5.00. Further, the following condition can be satisfied: 3.00<TD/f<4.80. Further, the following condition can be satisfied: 3.49≤TD/f≤4.55.

When a maximum field of view of the imaging optical lens system is FOV, the following condition is satisfied: 120.0 degrees<FOV<190.0 degrees. Therefore, it is favorable for obtaining the larger field of view of the imaging optical lens system, and enlarging the captured range of image. Further, the following condition can be satisfied: 125.0 degrees<FOV<190.0 degrees.

When an axial distance between the image-side surface of the eighth lens element and an image surface is BL, and a maximum image height of the imaging optical lens system is ImgH, the following condition is satisfied: 0.50<10×BL/ImgH<3.00. Therefore, it is favorable for shortening the back focal length of the imaging optical lens system so as to control the total track length thereof. Further, the following condition can be satisfied: 1.00<10×BL/ImgH<2.50.

The imaging optical lens system can further include an aperture stop, wherein when an axial distance between the aperture stop and the image surface is SL, and an axial distance between the object-side surface of the first lens element and the image surface is TL, the following condition is satisfied: 0.30<SL/TL<0.55. Therefore, it is favorable for controlling field of view and volume of the imaging optical lens system by adjusting the location of the aperture stop. Further, the following condition can be satisfied: 0.40<SL/TL<0.50.

When a central thickness of the first lens element is CT1, a central thickness of the second lens element is CT2, the central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, a maximum among CT1, CT2, CT3, CT4, CT5, CT6, CT7, CT8 is CTmax, and the focal length of the imaging optical lens system is f, the following condition is satisfied: 0.40<CTmax/f<1.20. Therefore, it is favorable for controlling the molding of the lens elements so as to decrease the difficulty of manufacturing. Further, the following condition can be satisfied: 0.65<CTmax/f<1.00.

When a composite focal length of the first lens element, the second lens element and the third lens element is f123, and a composite focal length of the fifth lens element, the sixth lens element and the seventh lens element is f567, the following condition is satisfied: 0.60<f123/f567<8.00. Therefore, it is favorable for enhancing the light receiving ability of larger field of view and controlling aberration. Further, the following condition can be satisfied: 1.50<f123/f567<7.00.

When a focal length of the sixth lens element is f6, and a focal length of the eighth lens element is f8, the following condition is satisfied: 0.00<|f6/f8|<2.00. Therefore, it is favorable for balancing the distribution of the refractive power of the image side of the imaging optical lens system, and correcting aberration. Further, the following condition can be satisfied: 0.40<|f6/f8|<1.40.

When the axial distance between the object-side surface of the first lens element and the image surface is TL, and the maximum image height of the imaging optical lens system is ImgH, the following condition is satisfied: 2.00<TL/ImgH<4.00. Therefore, it is favorable for compressing the total track length of the imaging optical lens system, and obtaining larger light receiving area thereof. Further, the following condition can be satisfied: 2.20<TL/ImgH<3.50. Further, the following condition can be satisfied: 2.40<TL/ImgH<3.00.

When the maximum image height of the imaging optical lens system is ImgH, and the focal length of the imaging optical lens system is f, the following condition is satisfied: 1.00<ImgH/f<2.00. Therefore, it is favorable for controlling field of view of the imaging optical lens system. Further, the following condition can be satisfied: 1.15<ImgH/f<1.85.

When the axial distance between the image-side surface of the eighth lens element and the image surface is BL, and the central thickness of the third lens element is CT3, the following condition is satisfied: 0.15<BL/CT3<0.70. Therefore, it is favorable for controlling the molding of the third lens element. Further, the following condition can be satisfied: 0.20<BL/CT3<0.40.

When an axial distance between the object-side surface of the second lens element and the image-side surface of the third lens element is Dr3r6, and an axial distance between the object-side surface of the fifth lens element and the image-side surface of the sixth lens element is Dr9r12, the following condition is satisfied: 1.60<Dr3r6/Dr9r12<3.00. Therefore, it is favorable for increasing the rate yield of assembling by adjusting the arrangement of the lens elements of the imaging optical lens system. Further, the following condition can be satisfied:

$$2. < D r 3 r 6 / Dr 9 r 12 < 2.8 .$$

When an axial distance between the first lens element and the second lens element is T12, and an axial distance between the sixth lens element and the seventh lens element is T67, the following condition is satisfied: 0.50<T12/T67<4.00. Therefore, it is favorable for balancing the space arrangement of the object side and the image side of the imaging optical lens system, and obtaining the characteristic of large field of view thereof. Further, the following condition can be satisfied: 0.80<T12/T67<2.50.

When the axial distance between the image-side surface of the eighth lens element and the image surface is BL, and the focal length of the imaging optical lens system is f, the following condition is satisfied: 1.50<10×BL/f<4.00. Therefore, it is favorable for shortening the back focal length so as to reducing the total track length of the imaging optical lens system. Further, the following condition can be satisfied: 2.00<10×BL/f<3.50.

When a focal length of the second lens element is f2, and a focal length of the fourth lens element is f4, the following condition is satisfied: 0.00<|f2/f4|<1.60. Therefore, it is favorable for balancing the distribution of refractive power of the object side of the imaging optical lens system, and correcting aberration. Further, the following condition can be satisfied: 0.25<|f2/f4|<1.40.

When a sum of central thicknesses of the lens elements of the imaging optical lens system is ΣCT, and a sum of all axial distances between adjacent lens elements of the imaging optical lens system is ΣAT, the following condition is satisfied: 1.20<ΣCT/ΣAT<2.50. Therefore, it is favorable for increasing the utilizing efficiency of the space. Further, the following condition can be satisfied:

$$1.4 < \sum CT / \sum AT < 2.4 .$$

When an axial distance between the object-side surface of the first lens element and the aperture stop is Dr1rs, and the focal length of the imaging optical lens system is f, the following condition is satisfied: 1.50<Dr1rs/f<3.50. Therefore, it is favorable for balancing the volume of the object side and the entire refractive power of the imaging optical lens system so as to enlarge field of view. Further, the following condition can be satisfied: 1.70<Dr1rs/f<3.00.

When an Abbe number of the sixth lens element is V6, the following condition is satisfied: 5.0<V6<26.0. Therefore, the material of the sixth lens element can be adjusted so as to correct chromatic aberration. Further, the following condition can be satisfied: 10.0<V6<26.0.

Each of the aforementioned features of the imaging optical lens system can be utilized in various combinations for achieving the corresponding effects.

According to the imaging optical lens system of the present disclosure, the lens elements thereof can be made of glass or plastic materials. When the lens elements are made of glass materials, the distribution of the refractive power of the imaging optical lens system may be more flexible to design. The glass lens element can either be made by grinding or molding. When the lens elements are made of plastic materials, manufacturing costs can be effectively reduced. Furthermore, surfaces of each lens element can be arranged to be aspheric (ASP), since the aspheric surface of the lens element is easy to form a shape other than a spherical surface so as to have more controllable variables for eliminating aberrations thereof, and to further decrease the required amount of lens elements in the imaging optical lens system. Therefore, the total track length of the imaging optical lens system can also be reduced. The aspheric surfaces may be formed by a plastic injection molding method, a glass molding method or other manufacturing methods.

According to the imaging optical lens system of the present disclosure, additives can be selectively added into any one (or more) material of the lens elements so as to change the transmittance of the lens element in a particular wavelength range. Therefore, the stray light and chromatic aberration can be reduced. For example, the additives can have the absorption ability for light in a wavelength range of 600 nm-800 nm in the imaging optical lens system so as to reduce extra red light or infrared light, or the additives can have the absorption ability for light in a wavelength range of 350 nm-450 nm in the imaging optical lens system so as to reduce blue light or ultraviolet light. Therefore, additives can prevent the image from interfering by light in a particular wavelength range. Furthermore, the additives can be homogeneously mixed with the plastic material, and the lens elements can be made by the injection molding method. Moreover, the additives can be coated on the lens surfaces to provide the aforementioned effects.

According to the imaging optical lens system of the present disclosure, when a surface of the lens element is aspheric, it indicates that entire optical effective region of the surface of the lens element or a part thereof is aspheric.

According to the imaging optical lens system of the present disclosure, when the lens elements have surfaces being convex and the convex surface position is not defined, it indicates that the aforementioned surfaces of the lens elements can be convex in the paraxial region thereof. When the lens elements have surfaces being concave and the concave surface position is not been defined, it indicates that the aforementioned surfaces of the lens elements can be concave in the paraxial region thereof. In the imaging optical lens system of the present disclosure, if the lens element has positive refractive power or negative refractive power, or the focal length of the lens element, all can be referred to the refractive power, or the focal length, in the paraxial region of the lens element.

According to the imaging optical lens system of the present disclosure, a critical point is a non-axial point of the lens surface where its tangent is perpendicular to the optical axis; an inflection point is a point on a lens surface with a curvature changing from positive to negative or from negative to positive.

According to the imaging optical lens system of the present disclosure, the image surface thereof, based on the corresponding image sensor, can be flat or curved. In particular, the image surface can be a concave curved surface facing towards the object side. Furthermore, the imaging optical lens system of the present disclosure can selectively include at least one image correcting element (such as a field flattener) inserted between the lens element closest to the image surface and the image surface, thus the effect of correcting image aberrations (such as field curvature) can be achieved. The optical properties of the aforementioned image correcting element, such as curvature, thickness, refractive index, position, surface shape (convex or concave, spherical or aspheric, diffraction surface and Fresnel surface, etc.) can be adjusted corresponding to the demands of the imaging apparatus. Generally, a preferred configuration of the image correcting element is to dispose a thin plano-concave element having a concave surface toward the object side on the position closed to the image surface.

Furthermore, according to the imaging optical lens system of the present disclosure, the imaging optical lens system can include at least one stop, such as an aperture stop, a glare stop or a field stop, for eliminating stray light and thereby improving image resolution thereof.

According to the imaging optical lens system of the present disclosure, the aperture stop can be configured as a front stop or a middle stop, wherein the front stop indicates that the aperture stop is disposed between an object and the first lens element, and the middle stop indicates that the aperture stop is disposed between the first lens element and the image surface. When the aperture stop is a front stop, a longer distance between an exit pupil of the imaging optical lens system and the image surface can be obtained, and thereby obtains a telecentric effect and improves the image-sensing efficiency of the image sensor, such as CCD or CMOS. The middle stop is favorable for enlarging the field of view of the imaging optical lens system and thereby provides a wider field of view for the same.

According to the imaging optical lens system of the present disclosure, an aperture control unit can be properly configured. The aperture control unit can be a mechanical element or a light controlling element, and the dimension and the shape of the aperture control unit can be electrically controlled. The mechanical element can include a moveable component such a blade group or a shielding plate. The light controlling element can include a screen component such as a light filter, an electrochromic material, a liquid crystal layer or the like. The amount of incoming light or the exposure time of the image can be controlled by the aperture control unit to enhance the image moderation ability. In addition, the aperture control unit can be the aperture stop of the imaging optical lens system according to the present disclosure, so as to moderate the image quality by changing f-number such as changing the depth of field or the exposure speed.

According to the imaging optical lens system of the present disclosure, one or more optical element can be properly configured so as to limit the way of light passing through the optical lens system. The aforementioned optical element can be a filter, a polarizer, etc., and it is not limited thereto. Moreover, the aforementioned optical element can be a single piece of element, a complex assembly or presented in a form of membrane, which is not limited thereto. The aforementioned optical element can be disposed at the object side, at the image side or between the lens elements of the imaging optical lens system so as to allow the specific light to pass through, which will meet the requirements of applications.

The imaging optical lens system according to the present disclosure can include at least one optical lens element, an optical element or a carrier. A low reflection layer is disposed on at least one surface of at least one optical lens element, the optical element or the carrier, wherein the low reflection layer is favorable for effectively reducing the stray light formed by the reflection of light on the interface. The low reflection layer can be disposed on the non-optically effective area of the object-side surface or the image-side surface of the optical lens element, or can be disposed on the connecting surface between the object-side surface or the image-side surface; wherein the optical element can be at least one of a light blocking element, an annular spacer element, a barrel element, a cover glass, a blue glass, a filter or a color filter, a light path folding element, a prism or a mirror, etc.; wherein the carrier can be a lens group lens mount, a micro lens disposed on the image sensor, the peripheral of the image sensor substrate or a glass sheet for protecting the image sensor, etc.

According to the imaging optical lens system of the present disclosure, the imaging optical lens system of the present disclosure can be applied to 3D (three-dimensional) image capturing applications, in products such as digital cameras, mobile devices, digital tablets, smart TVs, surveillance systems, motion sensing input devices, driving recording systems, rearview camera systems, wearable devices, unmanned aerial vehicles, and other electronic imaging products.

According to the present disclosure, an imaging apparatus including the aforementioned imaging optical lens system and an image sensor is provided, wherein the image sensor is disposed on the image surface of the imaging optical lens system. By the arrangement of the surface shape of the lens elements, it is favorable for obtaining the balance between the adjustment of the light traveling path and the volume of the imaging optical lens system, providing high image quality and maintaining the compactness thereof. Moreover, the imaging apparatus can further include a barrel member, a holder member or a combination thereof.

According to the present disclosure, an electronic device including the aforementioned imaging apparatus is provided. Therefore, the image quality can be increased. Moreover, the electronic device can further include a control unit, a display, a storage unit, a random-access memory unit (RAM) or a combination thereof.

According to the above description of the present disclosure, the following specific embodiments are provided for further explanation.

### 1ST EMBODIMENT

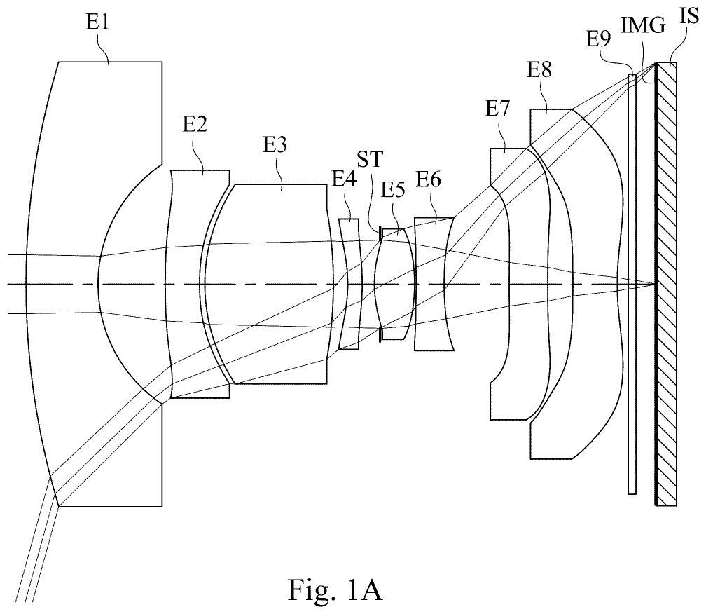

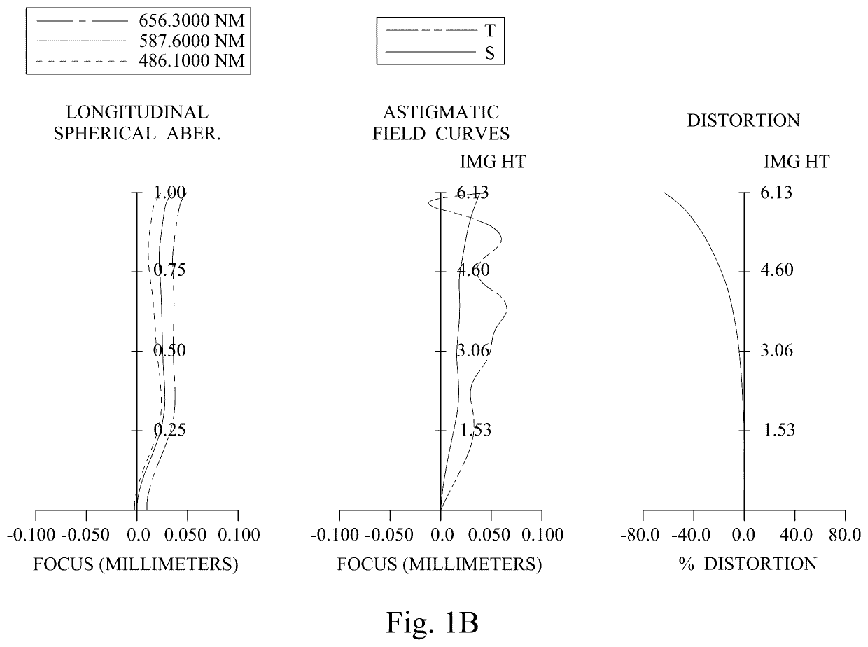

FIG. 1A is a schematic view of an imaging apparatus 1 according to the 1st embodiment of the present disclosure. FIG. 1B shows spherical aberration curves, astigmatic field curves and a distortion curve of the imaging apparatus 1 according to the 1st embodiment. In FIG. 1A, the imaging apparatus 1 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both spherical.

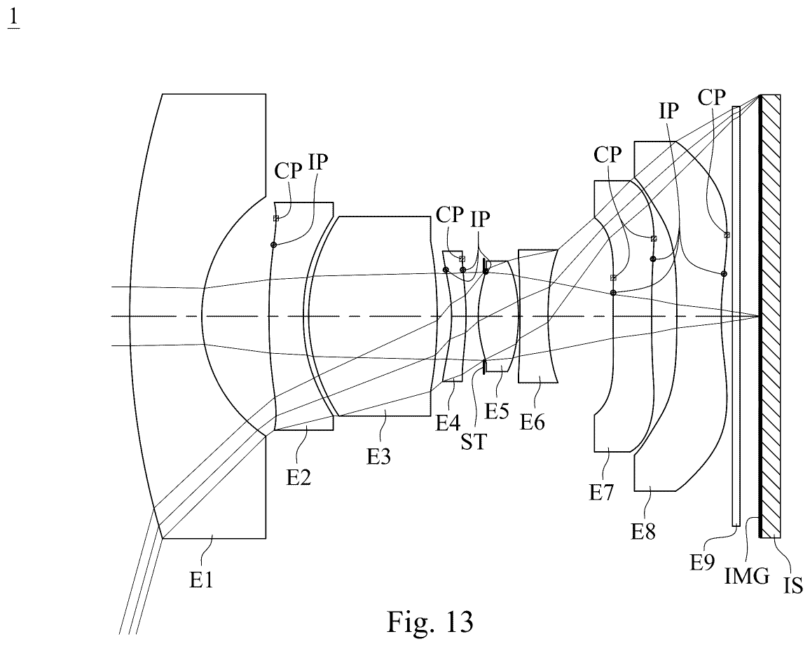

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, FIG. 13 is a schematic view of the inflection points IP and the critical points CP of each lens element according to the 1st embodiment. In FIG. 13, the object-side surface of the second lens element E2 includes one inflection point IP (as shown in FIG. 13) and one critical point CP (as shown in FIG. 13).

The third lens element E3 with positive refractive power has an object-side surface being convex in a paraxial region thereof and an image-side surface being convex in a paraxial region thereof. The third lens element E3 is made of glass material, and has the object-side surface and the image-side surface being both spherical.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point IP (as shown in FIG. 13), and the image-side surface of the fourth lens element E4 includes one inflection point IP (as shown in FIG. 13) and one critical point CP (as shown in FIG. 13).

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point IP (as shown in FIG. 13).

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric.

The seventh lens element E7 with positive refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point IP (as shown in FIG. 13) and one critical point CP (as shown in FIG. 13), and the image-side surface of the seventh lens element E7 includes one inflection point IP (as shown in FIG. 13) and one critical point CP (as shown in FIG. 13).

The eighth lens element E8 with negative refractive power has an object-side surface being concave in a paraxial region thereof and an image-side surface being concave in a paraxial region thereof. The eighth lens element E8 is made of plastic material, and has the object-side surface and the image-side surface being both aspheric. Furthermore, the image-side surface of the eighth lens element E8 includes one inflection point IP (as shown in FIG. 13) and one critical point CP (as shown in FIG. 13).

The filter E9 is made of glass material, which is located between the eighth lens element E8 and the image surface IMG in order, and will not affect the focal length of the imaging optical lens system.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from the intersection point of the aspheric surface and the optical axis to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient.

In the imaging optical lens system according to the 1st embodiment, when a focal length of the imaging optical lens system is f, an f-number of the imaging optical lens system is Fno, and half of a maximum field of view of the imaging optical lens system is HFOV, these parameters have the following values: f=4.56 mm; Fno=2.80; and HFOV=74.6 degrees.

In the imaging optical lens system according to the 1st embodiment, when a maximum field of view of the imaging optical lens system is FOV, the following condition is satisfied: FOV=149.2 degrees.

In the imaging optical lens system according to the 1st embodiment, when an axial distance between the object-side surface of the first lens element E1 and the image surface IMG is TL, and a maximum image height of the imaging optical lens system is ImgH, the following condition is satisfied: TL/ImgH=2.85.

In the imaging optical lens system according to the 1st embodiment, when an axial distance between the image-side surface of the eighth lens element E8 and the image surface IMG is BL, and the maximum image height of the imaging optical lens system is ImgH, the following condition is satisfied: 10×BL/ImgH=1.77.

In the imaging optical lens system according to the 1st embodiment, when an axial distance between the aperture stop ST and the image surface IMG is SL, and the axial distance between the object-side surface of the first lens element E1 and the image surface IMG is TL, and the following condition is satisfied:

$$SL / TL = 0.44 .$$

In the imaging optical lens system according to the 1st embodiment, when a central thickness of the first lens element E1 is CT1, a central thickness of the second lens element E2 is CT2, a central thickness of the third lens element E3 is CT3, a central thickness of the fourth lens element E4 is CT4, a central thickness of the fifth lens element E5 is CT5, a central thickness of the sixth lens element E6 is CT6, a central thickness of the seventh lens element E7 is CT7, a central thickness of the eighth lens element E8 is CT8, a maximum among CT1, CT2, CT3, CT4, CT5, CT6, CT7, CT8 is CTmax, and the focal length of the imaging optical lens system is f, the following condition is satisfied: CTmax/f=0.78.

In the imaging optical lens system according to the 1st embodiment, when the focal length of the imaging optical lens system is f, and the maximum image height of the imaging optical lens system is ImgH, the following condition is satisfied: ImgH/f=1.34.

In the imaging optical lens system according to the 1st embodiment, when an axial distance between the object-side surface of the first lens element E1 and the image-side surface of the eighth lens element E8 is TD, and the focal length of the imaging optical lens system is f, the following condition is satisfied: TD/f=3.59.

In the imaging optical lens system according to the 1st embodiment, when the axial distance between the image-side surface of the eighth lens element E8 and an image surface IMG is BL, and the focal length of the imaging optical lens system is f, the following condition is satisfied: 10×BL/f=2.38.

In the imaging optical lens system according to the 1st embodiment, when a focal length of the first lens element E1 is f1, a focal length of the second lens element E2 is f2, a focal length of the fourth lens element E4 is f4, a focal length of the sixth lens element E6 is f6, a focal length of the seventh lens element E7 is f7, and a focal length of the eighth lens element E8 is f8, the following conditions are satisfied: |f1/f7|=0.05; |f2/f4|=0.98; and |f6/f8|=0.98.

In the imaging optical lens system according to the 1st embodiment, when the focal length of the imaging optical lens system is f, and a composite focal length of the seventh lens element E7 and the eighth lens element E8 is f78, the following condition is satisfied: f/f78=−0.38.

In the imaging optical lens system according to the 1st embodiment, when a composite focal length of the first lens element E1, the second lens element E2 and the third lens element E3 is f123, and a composite focal length of the fifth lens element E5, the sixth lens element E6 and the seventh lens element E7 is f567, the following condition is satisfied: f123/f567=3.57.

In the imaging optical lens system according to the 1st embodiment, when an axial distance between the object-side surface of the first lens element E1 and the aperture stop ST is Dr1rs, and the focal length of the imaging optical lens system is f, the following condition is satisfied: Dr1rs/f=2.15.

In the imaging optical lens system according to the 1st embodiment, when a sum of central thicknesses of the lens elements of the imaging optical lens system is ΣCT, and a sum of all axial distances between adjacent lens elements of the imaging optical lens system is CAT, the following condition is satisfied:

$$\sum CT / \sum AT = 2.1 .$$

In the imaging optical lens system according to the 1st embodiment, when an axial distance between the first lens element E1 and the second lens element E2 is T12, and an axial distance between the sixth lens element E6 and the seventh lens element E7 is T67, the following condition is satisfied: T12/T67=1.03.

In the imaging optical lens system according to the 1st embodiment, when the axial distance between the image-side surface of the eighth lens element E8 and the image surface IMG is BL, and a central thickness of the third lens element E3 is CT3, the following condition is satisfied: BL/CT3=0.30.

In the imaging optical lens system according to the 1st embodiment, when an axial distance between the object-side surface of the second lens element E2 and the image-side surface of the third lens element E3 is Dr3r6, and an axial distance between the object-side surface of the fifth lens element E5 and the image-side surface of the sixth lens element E6 is Dr9r12, the following condition is satisfied: Dr3r6/Dr9r12=2.41.

In the imaging optical lens system according to the 1st embodiment, when a curvature radius of the image-side surface of the first lens element E1 is R2, and a curvature radius of the image-side surface of the second lens element E2 is R4, the following condition is satisfied: |R2/R4|=0.65.

In the imaging optical lens system according to the 1st embodiment, when an Abbe number of the sixth lens element E6 is V6, and an Abbe number of the eighth lens element E8 is V8, the following conditions are satisfied: V6=19.5; and V8=21.3.

The detailed optical data of the 1st embodiment are shown in Table 1A and the aspheric surface data are shown in Table 1B below.

TABLE 1A
1st Embodiment
f = 4.56 mm, Fno = 2.80, HFOV = 74.6 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 21.3354 | SPH | 1.994 | Glass | 1.804 | 46.5 | −6.43 |
| 2 | | 3.9907 | SPH | 1.864 | | | | |
| 3 | Lens 2 | 21.3666 | ASP | 0.952 | Plastic | 1.669 | 19.5 | −13.13 |
| 4 | | 6.1154 | ASP | 0.144 | | | | |
| 5 | Lens 3 | 4.9649 | SPH | 3.563 | Glass | 1.805 | 25.5 | 4.80 |
| 6 | | −11.9020 | SPH | 0.398 | | | | |
| 7 | Lens 4 | −3.9675 | ASP | 0.399 | Plastic | 1.650 | 21.8 | −13.43 |
| 8 | | −7.5644 | ASP | 0.495 | | | | |
| 9 | Ape. Stop | Plano | | −0.156 | | | | |
| 10 | Lens 5 | 3.1845 | ASP | 1.114 | Plastic | 1.544 | 56.0 | 3.74 |
| 11 | | −4.9226 | ASP | 0.041 | | | | |
| 12 | Lens 6 | −50.2334 | ASP | 0.777 | Plastic | 1.669 | 19.5 | −10.62 |
| 13 | | 8.3243 | ASP | 1.804 | | | | |
| 14 | Lens 7 | 46.6796 | ASP | 1.068 | Plastic | 1.544 | 56.0 | 129.34 |
| 15 | | 137.5606 | ASP | 0.696 | | | | |
| 16 | Lens 8 | −28.6557 | ASP | 1.231 | Plastic | 1.657 | 21.3 | −10.79 |
| 17 | | 9.5744 | ASP | 0.308 | | | | |

| | | | | | | | |
|---|---|---|---|---|---|---|---|
| 18 | Filter | Plano | 0.210 | Glass | 1.517 | 64.2 | — |
| 19 | | Plano | 0.565 | | | | |
| 20 | Image | Plano | — | | | | |

Reference wavelength is 587.6 nm (d-line).

TABLE 1B
Aspheric Coefficients

| Surface # | 3 | 4 | 7 | 8 |
|---|---|---|---|---|
| k= | 3.34498E+01 | −3.35433E+00 | −1.12545E+01 | −2.19289E+01 |
| A4= | 4.404151309E−03 | 9.730228407E−03 | 4.745594163E−03 | 1.729014195E−03 |
| A6= | −8.059004598E−04 | −1.027212873E−03 | −1.764508197E−03 | 8.170254839E−04 |
| A8= | 5.443247413E−05 | 2.207304363E−04 | 6.230145548E−04 | 2.508646124E−05 |
| A10= | 5.910857773E−06 | −6.363910582E−05 | −3.561634583E−05 | 1.061293126E−04 |
| A12= | −5.323309892E−06 | 7.428942501E−06 | | |
| A14= | 1.033504097E−06 | −4.524127963E−07 | | |
| A16= | −9.467315825E−08 | 9.187022186E−08 | | |
| A18= | 4.288817804E−09 | −1.461413629E−08 | | |
| A20= | −7.700470157E−11 | 7.421229368E−10 | | |

| Surface # | 10 | 11 | 12 | 13 |
|---|---|---|---|---|
| k= | −6.01470E+00 | 5.71129E−02 | 8.72632E+01 | −8.80396E+01 |
| A4= | 4.164787849E−04 | −1.079602153E−02 | −1.119285135E−02 | 2.137199566E−02 |
| A6= | 1.567419787E−03 | −1.433375388E−02 | 1.881733629E−02 | −8.782002530E−03 |
| A8= | −4.883888259E−04 | 8.923990874E−02 | −1.575222680E−02 | 6.729380862E−03 |
| A10= | −1.521182977E−03 | −1.929434137E−01 | 8.200106541E−03 | −3.803607054E−03 |
| A12= | 1.186374542E−03 | 2.349895574E−01 | −2.935036898E−03 | 1.462733603E−03 |
| A14= | −3.052910339E−04 | −1.789219571E−01 | 6.351136501 E−04 | −3.740979641E−04 |
| A16= | | 8.635160990E−02 | −6.044993684E−05 | 5.711761991E−05 |
| A18= | | −2.559960641E−02 | | −3.892148631E−06 |
| A20= | | 4.241624774E−03 | | |
| A22= | | −2.999834957E−04 | | |
| Surface # | 14 | 15 | 16 | 17 |
| k= | 9.43524E+01 | 8.73546E+01 | −9.87776E+01 | −1.41480E+01 |
| A4= | −7.455244967E−03 | 7.414802463E−03 | 7.807741768E−03 | 1.961173459E−02 |
| A6= | 5.986363165E−03 | −9.161485578E−04 | −1.246233125E−02 | −1.881784567E−02 |
| A8= | −5.186785722E−03 | −7.285739434E−05 | 5.132167179E−03 | 8.050058357E−03 |
| A10= | 2.334356007E−03 | −2.926981777E−05 | −8.710614984E−04 | −2.300721838E−03 |
| A12= | −7.172444166E−04 | 1.447028511E−05 | −1.075041238E−04 | 4.706458196E−04 |
| A14= | 1.553024928E−04 | −2.178547868E−06 | 9.587123636E−05 | −7.042724596E−05 |
| A16= | −2.283046576E−05 | 1.608816203E−07 | −2.613223863E−05 | 7.750513381E−06 |
| A18= | 2.108224253E−06 | −5.975756784E−09 | 4.321756582E−06 | −6.265771937E−07 |
| A20= | −1.074724576E−07 | 8.888459768E−11 | −4.812893170E−07 | 3.696504297E−08 |
| A22= | 2.234495702E−09 | | 3.689693981E−08 | −1.568044446E−09 |
| A24= | | | −1.923089333E−09 | 4.648974080E−11 |
| A26= | | | 6.514047098E−11 | −9.134275887E−13 |
| A28= | | | −1.293698878E−12 | 1.067949638E−14 |
| A30= | | | 1.143417006E−14 | −5.622628472E−17 |

In Table 1A, the curvature radius, the thickness and the focal length are shown in millimeters (mm). Surface numbers 0-20 represent the surfaces sequentially arranged from the object side to the image side along the optical axis. In Table 1B, k represents the conic coefficient of the equation of the aspheric surface profiles. A4-A30 represent the aspheric coefficients ranging from the 4th order to the 30th order. The tables presented below for each embodiment correspond to schematic parameter and aberration curves of each embodiment, and term definitions of the tables are the same as those in Table 1A and Table 1B of the 1st embodiment. Therefore, an explanation in this regard will not be provided again.

### 2ND EMBODIMENT

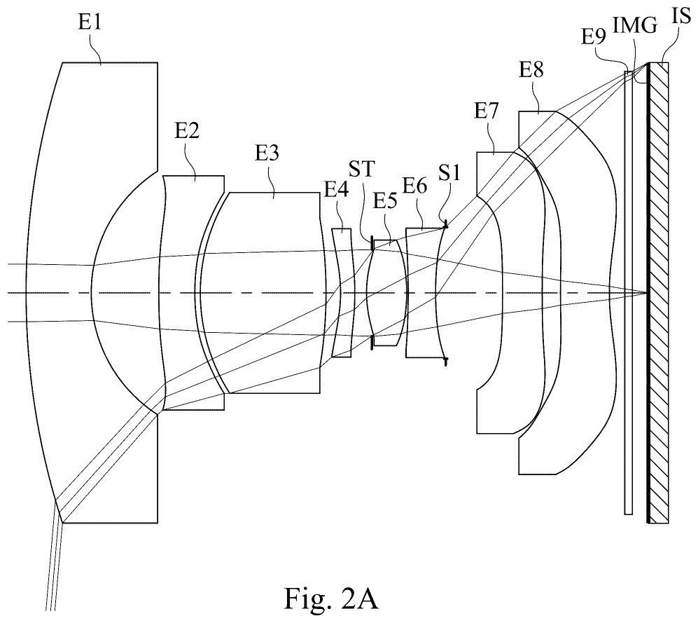

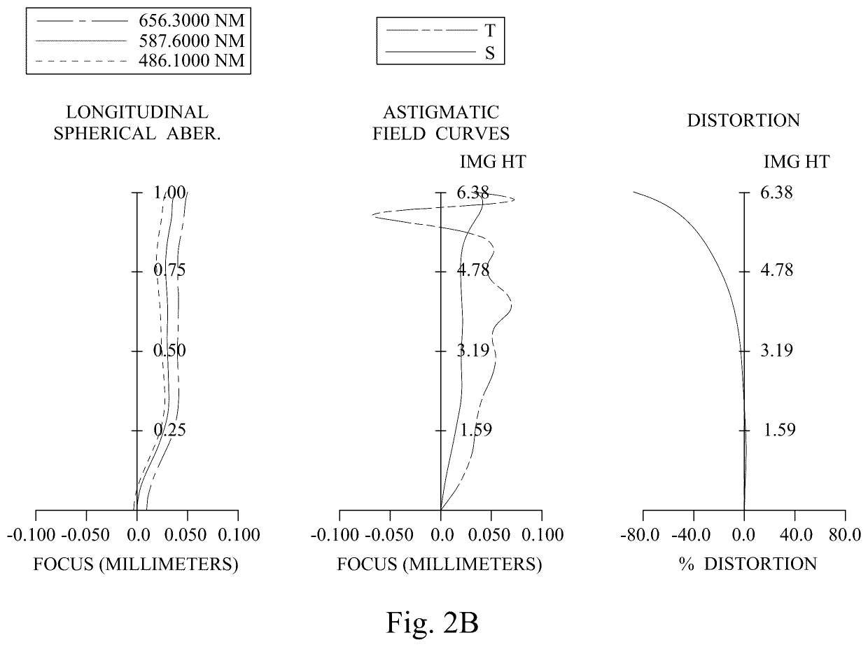

FIG. 2A is a schematic view of an imaging apparatus 2 according to the 2nd embodiment of the present disclosure. FIG. 2B shows spherical aberration curves, astigmatic field curves and a distortion curve of the imaging apparatus 2 according to the 2nd embodiment. In FIG. 2A, the imaging apparatus 2 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a stop S1, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both spherical.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point and one critical point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric.

The seventh lens element E7 with negative refractive power has an object-side surface being concave in a paraxial region thereof and an image-side surface being concave in a paraxial region thereof. The seventh lens element E7 is made of plastic material, and has the object-side surface and the image-side surface being both aspheric. Furthermore, the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 2nd embodiment are shown in Table 2A and the aspheric surface data are shown in Table 2B below.

TABLE 2A
2nd Embodiment
f = 4.47 mm, Fno = 2.80, HFOV = 85.1 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 20.6159 | SPH | 1.806 | Glass | 1.804 | 46.5 | −6.51 |
| 2 | | 4.0101 | SPH | 1.875 | | | | |
| 3 | Lens 2 | 21.9123 | ASP | 0.999 | Plastic | 1.661 | 20.3 | −13.91 |
| 4 | | 6.3560 | ASP | 0.148 | | | | |
| 5 | Lens 3 | 5.1547 | SPH | 3.489 | Glass | 1.805 | 25.5 | 4.97 |
| 6 | | −12.5058 | SPH | 0.402 | | | | |
| 7 | Lens 4 | −4.0261 | ASP | 0.394 | Plastic | 1.650 | 21.8 | −14.00 |
| 8 | | −7.5019 | ASP | 0.472 | | | | |
| 9 | Ape. Stop | Plano | | −0.146 | | | | |
| 10 | Lens 5 | 3.1009 | ASP | 1.114 | Plastic | 1.544 | 56.0 | 3.59 |
| 11 | | −4.6090 | ASP | 0.040 | | | | |
| 12 | Lens 6 | −26.5751 | ASP | 0.760 | Plastic | 1.669 | 19.5 | −10.10 |
| 13 | | 9.1695 | ASP | 0.280 | | | | |
| 14 | Stop | Plano | | 1.577 | | | | |
| 15 | Lens 7 | −43.4783 | ASP | 1.099 | Plastic | 1.544 | 56.0 | −44.93 |
| 16 | | 56.3180 | ASP | 0.507 | | | | |
| 17 | Lens 8 | 36.4447 | ASP | 1.356 | Plastic | 1.669 | 19.5 | −18.22 |
| 18 | | 8.9990 | ASP | 0.426 | | | | |

| | | | | | | | |
|---|---|---|---|---|---|---|---|
| 19 | Filter | Plano | 0.210 | Glass | 1.517 | 64.2 | — |
| 20 | | Plano | 0.444 | | | | |
| 21 | Image | Plano | — | | | | |

Reference wavelength is 587.6 nm (d-line).
Effective radius of Surface 14 (stop S1) is 1.822 mm.

TABLE 2B
Aspheric Coefficients

| Surface # | 3 | 4 | 7 | 8 |
|---|---|---|---|---|
| k= | 2.69247E+01 | −3.67880E+00 | −1.15093E+01 | −2.08589E+01 |
| A4= | 4.742694959E−03 | 1.001114790E−02 | 5.218665063E−03 | 1.477628330E−03 |
| A6= | −9.148523298E−04 | −1.165084869E−03 | −2.422556650E−03 | 7.158927860E−04 |
| A8= | 1.036647736E−04 | 2.110224814E−04 | 9.030250510E−04 | 1.876093935E−04 |
| A10= | −9.682289051E−06 | −2.126682208E−05 | −7.813012843E−05 | 8.040392306E−05 |
| A12= | −1.893812614E−06 | −1.527634299E−05 | | |
| A14= | 4.843829581E−07 | 5.208353657E−06 | | |
| A16= | −3.577611289E−08 | −6.479113462E−07 | | |
| A18= | 7.157037269E−10 | 3.437243422E−08 | | |
| A20= | 1.387506328E−11 | −5.502052652E−10 | | |
| Surface # | 10 | 11 | 12 | 13 |
| k= | −5.82270E+00 | 2.42949E−01 | 8.95580E+01 | −9.67900E+01 |
| A4= | 8.819507849E−04 | −1.023764302E−02 | −1.093355535E−02 | 2.010439703E−02 |
| A6= | 1.130779755E−03 | −2.596038326E−02 | 1.902339790E−02 | −6.966662620E−03 |
| A8= | 5.316721686E−04 | 1.364711001E−01 | −1.697085524E−02 | 5.240289268E−03 |
| A10= | −2.606529468E−03 | −3.031830693E−01 | 9.871636734E−03 | −2.995760627E−03 |
| A12= | 1.746387853E−03 | 3.945027242E−01 | −3.837633772E−03 | 1.220667258E−03 |
| A14= | −4.262191223E−04 | −3.253838622E−01 | 8.409628763E−04 | −3.415593339E−04 |
| A16= | | 1.717299905E−01 | −7.653588442E−05 | 5.665774639E−05 |
| A18= | | −5.619789553E−02 | | −4.069318745E−06 |
| A20= | | 1.038425748E−02 | | |
| A22= | | −8.282262961E−04 | | |

| Surface # | 15 | 16 | 17 | 18 |
|---|---|---|---|---|
| k= | 3.68766E+01 | 9.90000E+01 | −9.90000E+01 | −9.17757E+00 |
| A4= | −1.089097853E−02 | 1.249040531E−03 | 8.823483115E−03 | 3.164672600E−02 |
| A6= | 1.482553002E−02 | 3.436903520E−03 | −1.955808274E−02 | −3.047043618E−02 |
| A8= | −1.452120438E−02 | −1.622964088E−03 | 1.207573494E−02 | 1.380923464E−02 |
| A10= | 8.111626680E−03 | 2.992716907E−04 | −4.644688481E−03 | −4.084325856E−03 |
| A12= | −3.024165341E−03 | −2.872459760E−05 | 1.244794558E−03 | 8.438177247E−04 |
| A14= | 7.642312093E−04 | 1.322835853E−06 | −2.441128410E−04 | −1.253328246E−04 |
| A16= | −1.283209945E−04 | −6.101531092E−09 | 3.548163900E−05 | 1.356227342E−05 |
| A18= | 1.361537925E−05 | −1.804323502E−09 | −3.812382196E−06 | −1.073865196E−06 |
| A20= | −8.224179374E−07 | 4.907776338E−11 | 3.001016461E−07 | 6.198821852E−08 |
| A22= | 2.147368978E−08 | | −1.702999752E−08 | −2.573424368E−09 |
| A24= | | | 6.765971427E−10 | 7.470433878E−11 |
| A26= | | | −1.782450964E−11 | −1.437520266E−12 |
| A28= | | | 2.791120431E−13 | 1.645902011E−14 |
| A30= | | | −1.961076387E−15 | −8.482219501E−17 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions in Table 2C:

TABLE 2C
2nd Embodiment

| | | | |
|---|---|---|---|
| f [mm] | 4.47 | \|f2/f4\| | 0.99 |
| Fno | 2.80 | \|f6/f8\| | 0.55 |
| HFOV [deg.] | 85.1 | f/f78 | −0.36 |
| FOV [deg.] | 170.1 | f123/f567 | 3.82 |
| TL/ImgH | 2.71 | Dr1rs/f | 2.15 |
| 10 × BL/ImgH | 1.69 | ΣCT/ΣAT | 2.14 |
| SL/TL | 0.44 | T12/T67 | 1.01 |
| CTmax/f | 0.78 | BL/CT3 | 0.31 |
| ImgH/f | 1.43 | Dr3r6/Dr9r12 | 2.42 |
| TD/f | 3.62 | \|R2/R4\| | 0.63 |
| 10 × BL/f | 2.42 | V6 | 19.5 |
| \|f1/f7\| | 0.14 | V8 | 19.5 |

### 3RD EMBODIMENT

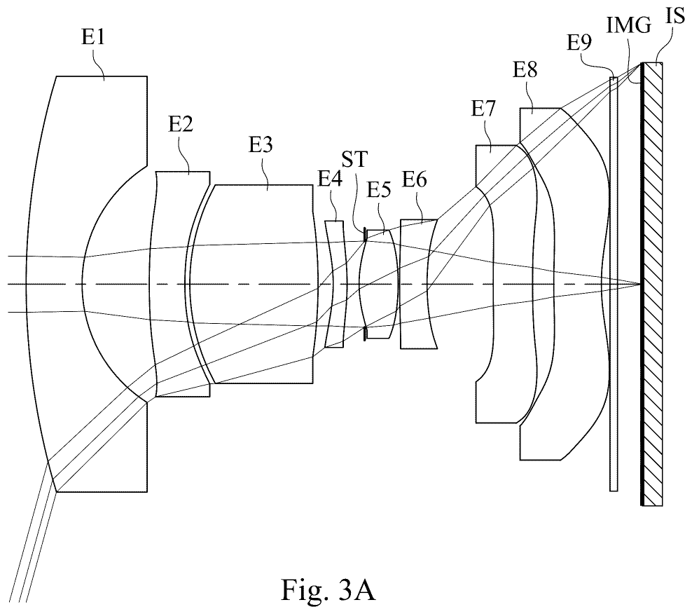

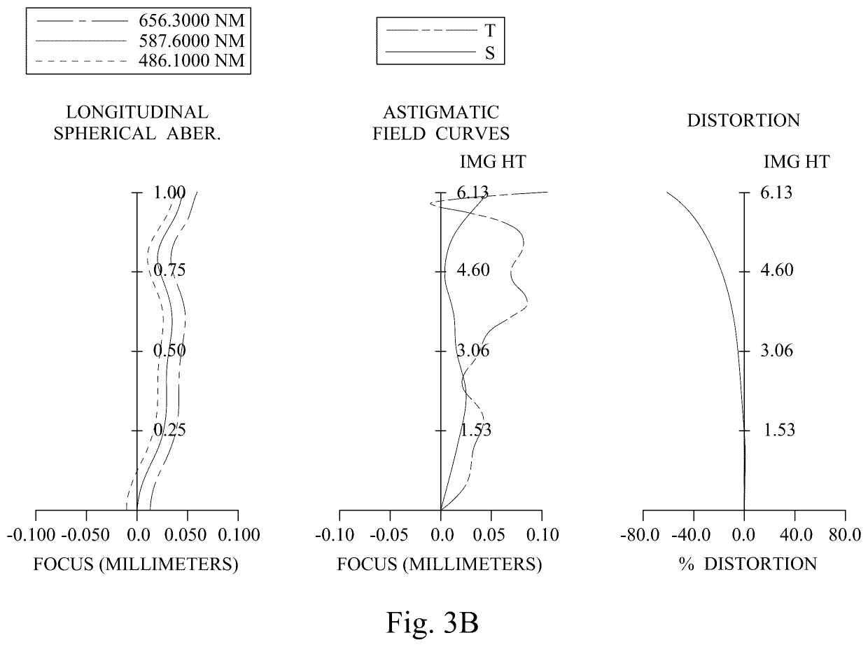

FIG. 3A is a schematic view of an imaging apparatus 3 according to the 3rd embodiment of the present disclosure. FIG. 3B shows spherical aberration curves, astigmatic field curves and a distortion curve of the imaging apparatus 3 according to the 3rd embodiment. In FIG. 3A, the imaging apparatus 3 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both spherical.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being convex in a paraxial region thereof and an image-side surface being concave in a paraxial region thereof. The sixth lens element E6 is made of plastic material, and has the object-side surface and the image-side surface being both aspheric. Furthermore, the object-side surface of the sixth lens element E6 includes one inflection point and one critical point.

The seventh lens element E7 with negative refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes three inflection points and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 3rd embodiment are shown in Table 3A and the aspheric surface data are shown in Table 3B below.

TABLE 3A
3rd Embodiment
f = 4.35 mm, Fno = 2.80, HFOV = 74.6 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 20.1393 | SPH | 1.547 | Glass | 1.804 | 46.5 | −6.24 |
| 2 | | 3.8779 | SPH | 1.866 | | | | |
| 3 | Lens 2 | 20.9140 | ASP | 0.986 | Plastic | 1.669 | 19.5 | −17.55 |
| 4 | | 7.3775 | ASP | 0.135 | | | | |
| 5 | Lens 3 | 5.6914 | SPH | 3.556 | Glass | 1.805 | 25.5 | 5.46 |
| 6 | | −13.8798 | SPH | 0.419 | | | | |
| 7 | Lens 4 | −4.1599 | ASP | 0.384 | Plastic | 1.642 | 22.5 | −14.75 |
| 8 | | −7.6899 | ASP | 0.486 | | | | |
| 9 | Ape. Stop | Plano | | −0.153 | | | | |
| 10 | Lens 5 | 3.1771 | ASP | 1.083 | Plastic | 1.544 | 56.0 | 3.99 |
| 11 | | −6.0275 | ASP | 0.040 | | | | |
| 12 | Lens 6 | 22.2028 | ASP | 0.760 | Plastic | 1.697 | 16.3 | −14.11 |
| 13 | | 6.7195 | ASP | 1.833 | | | | |
| 14 | Lens 7 | 35.0298 | ASP | 1.091 | Plastic | 1.544 | 56.0 | −552.75 |
| 15 | | 31.0307 | ASP | 0.588 | | | | |
| 16 | Lens 8 | 24.3940 | ASP | 1.319 | Plastic | 1.669 | 19.5 | −14.85 |
| 17 | | 6.9061 | ASP | 0.237 | | | | |

| | | | | | | | |
|---|---|---|---|---|---|---|---|
| 18 | Filter | Plano | 0.210 | Glass | 1.517 | 64.2 | — |
| 19 | | Plano | 0.686 | | | | |
| 20 | Image | Plano | — | | | | |

Reference wavelength is 587.6 nm (d-line).

TABLE 3B
Aspheric Coefficients

| Surface # | 3 | 4 | 7 | 8 |
|---|---|---|---|---|
| k= | 3.00165E+01 | −4.77345E+00 | −1.21814E+01 | −1.84208E+01 |
| A4= | 4.908906731E−03 | 9.676551519E−03 | 4.202808135E−03 | 1.366975321E−03 |
| A6= | −2.148829125E−03 | −3.091625605E−03 | −1.162462365E−03 | 1.075508481E−03 |
| A8= | 1.067607809E−03 | 2.176902190E−03 | 4.460637021E−04 | 6.247210022E−05 |
| A10= | −3.812365188E−04 | −1.056000144E−03 | −1.657874025E−05 | 5.369891219E−05 |
| A12= | 8.327342135E−05 | 3.126471943E−04 | | |
| A14= | −1.149181234E−05 | −5.840149603E−05 | | |
| A16= | 9.744830355E−07 | 6.702190717E−06 | | |
| A18= | −4.616847787E−08 | −4.289682122E−07 | | |
| A20= | 9.326773700E−10 | 1.168287714E−08 | | |

| Surface # | 10 | 11 | 12 | 13 |
|---|---|---|---|---|
| k= | −5.83918E+00 | 1.08784E+00 | −9.88380E+01 | −5.46905E+01 |
| A4= | 8.114757048E−04 | −1.398529638E−02 | −1.564533770E−02 | 2.250973991E−02 |
| A6= | −1.653038382E−03 | −3.969634172E−02 | 2.239073788E−02 | −5.976193361E−03 |
| A8= | 8.287152481E−03 | 2.214416533E−01 | −1.820517110E−02 | 2.092110639E−03 |
| A10= | −1.064200086E−02 | −5.078574038E−01 | 8.711737956E−03 | −9.490038120E−04 |
| A12= | 5.579043137E−03 | 6.695310357E−01 | −2.634632151E−03 | 6.297614804E−04 |
| A14= | −1.118823121E−03 | −5.493280155E−01 | 4.848823247E−04 | −2.844771087E−04 |
| A16= | | 2.838625930E−01 | −4.466874700E−05 | 6.435706561E−05 |
| A18= | | −8.959435611E−02 | | −5.711859347E−06 |
| A20= | | 1.572708282E−02 | | |
| A22= | | −1.172625242E−03 | | |
| Surface # | 14 | 15 | 16 | 17 |
| k= | −6.90863E+01 | 4.69554E+01 | −9.90000E+01 | −1.58292E+01 |
| A4= | −1.044262525E−02 | 1.990830121E−03 | 3.720503839E−03 | 2.925782360E−02 |
| A6= | 1.120107108E−02 | 2.945896708E−03 | −9.822448441E−03 | −2.907425985E−02 |
| A8= | −8.407207247E−03 | −1.509893672E−03 | 3.545205005E−03 | 1.355239856E−02 |
| A10= | 3.362648604E−03 | 2.938667860E−04 | −2.363978580E−04 | −4.124373778E−03 |
| A12= | −8.383625092E−04 | −3.087623460E−05 | −2.411429407E−04 | 8.757211095E−04 |
| A14= | 1.302545325E−04 | 1.789864016E−06 | 1.011978791E−04 | −1.332636819E−04 |
| A16= | −1.147174877E−05 | −4.875323537E−08 | −2.156130272E−05 | 1.471584242E−05 |
| A18= | 3.601853116E−07 | 1.220603854E−10 | 2.987589463E−06 | −1.184528821E−06 |
| A20= | 1.999241006E−08 | 1.423959694E−11 | −2.865786996E−07 | 6.929194522E−08 |
| A22= | −1.437727140E−09 | | 1.926142116E−08 | −2.908486594E−09 |
| A24= | | | −8.923695136E−10 | 8.523892317E−11 |
| A26= | | | 2.717933616E−11 | −1.654576316E−12 |
| A28= | | | −4.901585183E−13 | 1.910386716E−14 |
| A30= | | | 3.967564108E−15 | −9.928627379E−17 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions in Table 3C:

TABLE 3C
3rd Embodiment

| | | | |
|---|---|---|---|
| f [mm] | 4.35 | \|f2/f4\| | 1.19 |
| Fno | 2.80 | \|f6/f8\| | 0.95 |
| HFOV [deg.] | 74.6 | f/f78 | −0.30 |
| FOV [deg.] | 149.2 | f123/f567 | 5.42 |
| TL/ImgH | 2.79 | Dr1rs/f | 2.16 |
| 10 × BL/ImgH | 1.85 | ΣCT/ΣAT | 2.06 |
| SL/TL | 0.45 | T12/T67 | 1.02 |
| CTmax/f | 0.82 | BL/CT3 | 0.32 |
| ImgH/f | 1.41 | Dr3r6/Dr9r12 | 2.48 |
| TD/f | 3.67 | \|R2/R4\| | 0.53 |
| 10 × BL/f | 2.61 | V6 | 16.3 |
| \|f1/f7\| | 0.01 | V8 | 19.5 |

### 4TH EMBODIMENT

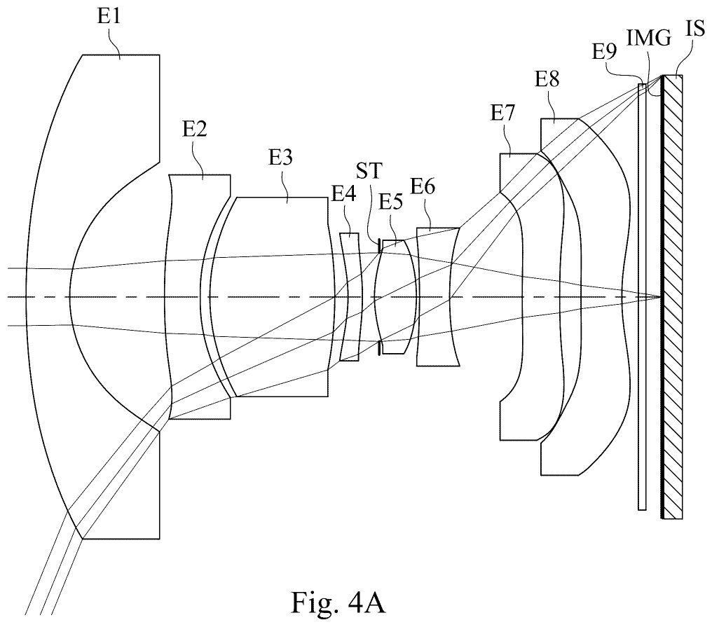

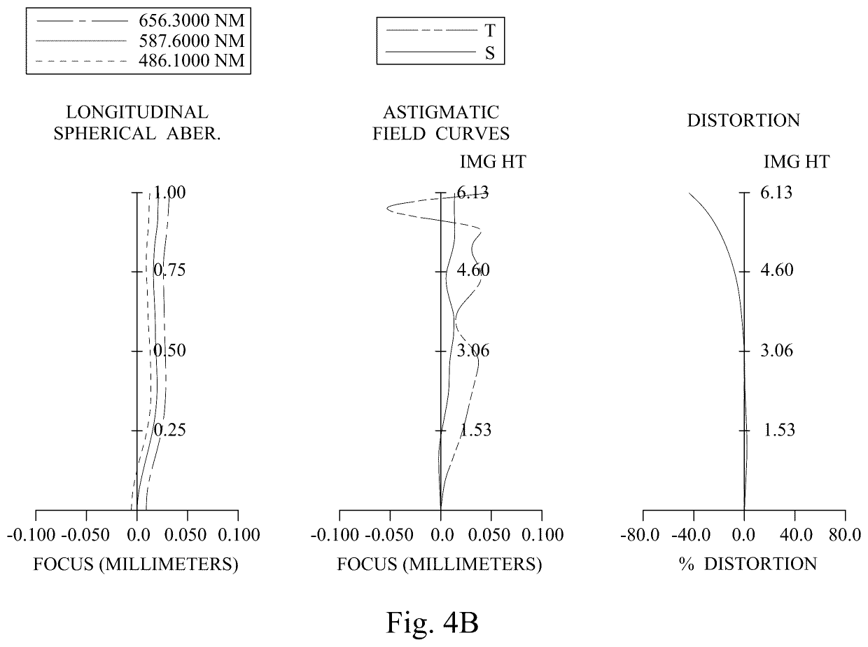

FIG. 4A is a schematic view of an imaging apparatus 4 according to the 4th embodiment of the present disclosure. FIG. 4B shows spherical aberration curves, astigmatic field curves and a distortion curve of the imaging apparatus 4 according to the 4th embodiment. In FIG. 4A, the imaging apparatus 4 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric.

The seventh lens element E7 with positive refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 4th embodiment are shown in Table 4A and the aspheric surface data are shown in Table 4B below.

TABLE 4A
4th Embodiment
f = 4.44 mm, Fno = 2.80, HFOV = 67.8 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 19.2091 | ASP | 1.210 | Plastic | 1.535 | 55.9 | −9.02 |
| 2 | | 3.7704 | ASP | 2.624 | | | | |
| 3 | Lens 2 | 20.8407 | ASP | 0.989 | Plastic | 1.661 | 20.3 | −14.03 |
| 4 | | 6.2952 | ASP | 0.268 | | | | |
| 5 | Lens 3 | 5.3196 | ASP | 3.458 | Plastic | 1.614 | 25.6 | 6.36 |
| 6 | | −11.0023 | ASP | 0.366 | | | | |
| 7 | Lens 4 | −4.2782 | ASP | 0.398 | Plastic | 1.587 | 28.3 | −17.06 |
| 8 | | −7.7243 | ASP | 0.465 | | | | |
| 9 | Ape. Stop | Plano | | −0.129 | | | | |
| 10 | Lens 5 | 3.2885 | ASP | 1.161 | Plastic | 1.544 | 56.0 | 3.68 |
| 11 | | −4.4890 | ASP | 0.086 | | | | |
| 12 | Lens 6 | −23.6355 | ASP | 0.833 | Plastic | 1.669 | 19.5 | −9.52 |
| 13 | | 8.8453 | ASP | 2.012 | | | | |
| 14 | Lens 7 | 35.4312 | ASP | 1.038 | Plastic | 1.566 | 37.4 | 700.80 |
| 15 | | 38.4942 | ASP | 0.588 | | | | |
| 16 | Lens 8 | 53.6446 | ASP | 1.133 | Plastic | 1.661 | 20.3 | −13.87 |
| 17 | | 7.7608 | ASP | 0.457 | | | | |

| | | | | | | | |
|---|---|---|---|---|---|---|---|
| 18 | Filter | Plano | 0.210 | Glass | 1.517 | 64.2 | — |
| 19 | | Plano | 0.453 | | | | |
| 20 | Image | Plano | — | | | | |

Reference wavelength is 587.6 nm (d-line).

TABLE 4B
Aspheric Coefficients

| Surface # | 1 | 2 | 3 | 4 |
|---|---|---|---|---|
| k= | 3.46735E+00 | −1.43461E−01 | 2.80817E+01 | −3.30227E+00 |
| A4= | 5.133879252E−05 | −8.819413050E−04 | 3.681352428E−03 | 8.970547637E−03 |
| A6= | 5.967022048E−06 | 6.652848761E−04 | 2.526072385E−04 | 4.344164845E−04 |
| A8= | −1.099125147E−08 | −2.013430425E−04 | −4.504405077E−04 | −7.739487802E−04 |
| A10= | −4.697263256E−09 | 4.269709875E−05 | 1.233720785E−04 | 2.606561207E−04 |
| A12= | −3.098736099E−10 | −6.078523628E−06 | −1.912064799E−05 | −4.366421411E−05 |
| A14= | 1.923788585E−11 | 5.343744728E−07 | 1.712228976E−06 | 1.867986876E−06 |
| A16= | −3.458032891E−13 | −2.555870338E−08 | −8.479502059E−08 | 4.642054071E−07 |
| A18= | 2.152420451E−15 | 4.896862607E−10 | 2.057192934E−09 | −6.734951903E−08 |
| A20= | | | −1.677429974E−11 | 2.704720418E−09 |

| Surface # | 5 | 6 | 7 | 8 |
|---|---|---|---|---|
| k= | −1.90758E−01 | 1.24616E+00 | −1.19749E+01 | −1.67664E+01 |
| A4= | −1.369879330E−04 | 6.452656385E−04 | 6.353302480E−03 | 1.411541069E−03 |
| A6= | 3.368378935E−05 | −4.660885337E−04 | −3.510651421E−03 | 1.320880673E−04 |
| A8= | 2.711738258E−06 | 6.545724623E−05 | 1.329347411E−03 | 5.812557888E−04 |
| A10= | −3.250218079E−06 | 5.789175622E−06 | −1.293352447E−04 | 6.286685765E−06 |
| A12= | 2.784912719E−07 | −1.393675720E−06 | | |

| Surface # | 10 | 11 | 12 | 13 |
|---|---|---|---|---|
| k= | −6.28027E+00 | −3.79283E−01 | 1.72925E+01 | −9.90000E+01 |
| A4= | 1.323463956E−04 | −9.058125561E−03 | −7.649706324E−03 | 2.037876690E−02 |
| A6= | 5.748938502E−04 | −9.964799884E−03 | 9.587823194E−03 | −8.902796696E−03 |
| A8= | 5.671878521E−04 | 4.761751453E−02 | −6.639116193E−03 | 6.458097414E−03 |
| A10= | −1.896617896E−03 | −9.264523243E−02 | 3.291103898E−03 | −3.445988698E−03 |
| A12= | 1.160176545E−03 | 1.047132987E−01 | −1.226300603E−03 | 1.257011002E−03 |
| A14= | −2.652426228E−04 | −7.470417181E−02 | 2.525132127E−04 | −3.002177143E−04 |
| A16= | | 3.383226890E−02 | −1.973116231E−05 | 4.139006494E−05 |
| A18= | | −9.416644930E−03 | | −2.448978714E−06 |
| A20= | | 1.466923655E−03 | | |
| A22= | | −9.783467009E−05 | | |

| Surface # | 14 | 15 | 16 | 17 |
|---|---|---|---|---|
| k= | 9.28754E+01 | 5.89968E+01 | −6.83281E+01 | −1.04902E+01 |
| A4= | −4.793928545E−03 | 6.653356809E−03 | 8.473246977E−03 | 3.513383506E−02 |
| A6= | 3.434778734E−03 | −6.722976914E−04 | −1.784566464E−02 | −3.340700782E−02 |
| A8= | −3.483817251E−03 | −2.837592677E−06 | 1.092940079E−02 | 1.487946556E−02 |
| A10= | 1.514899603E−03 | −7.743975773E−05 | −4.386527825E−03 | −4.255094444E−03 |
| A12= | −4.015559470E−04 | 2.556455089E−05 | 1.314090815E−03 | 8.421372346E−04 |
| A14= | 6.697422366E−05 | −3.519262349E−06 | −3.043267496E−04 | −1.193320381E−04 |
| A16= | −6.839055281E−06 | 2.509614422E−07 | 5.330094693E−05 | 1.229430416E−05 |
| A18= | 3.822333255E−07 | −9.159298163E−09 | −6.861831678E−06 | −9.253748847E−07 |
| A20= | −7.933332211E−09 | 1.353501154E−10 | 6.366187572E−07 | 5.069490616E−08 |
| A22= | −8.326472719E−11 | | −4.180229185E−08 | −1.993822616E−09 |
| A24= | | | 1.889992664E−09 | 5.472999453E−11 |
| A26= | | | −5.590452880E−11 | −9.938955605E−13 |
| A28= | | | 9.734798827E−13 | 1.071703692E−14 |
| A30= | | | −7.565683881E−15 | −5.189934337E−17 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A and Table 4B as the following values and satisfy the following conditions in Table 4C:

TABLE 4C
4th Embodiment

| | | | |
|---|---|---|---|
| f [mm] | 4.44 | \|f2/f4\| | 0.82 |
| Fno | 2.80 | \|f6/f8\| | 0.69 |
| HFOV [deg.] | 67.8 | f/f78 | −0.31 |
| FOV [deg.] | 135.5 | f123/f567 | 6.13 |
| TL/ImgH | 2.87 | Dr1rs/f | 2.20 |
| 10 × BL/ImgH | 1.83 | ΣCT/ΣAT | 1.63 |
| SL/TL | 0.45 | T12/T67 | 1.30 |
| CTmax/f | 0.78 | BL/CT3 | 0.32 |
| ImgH/f | 1.38 | Dr3r6/Dr9r12 | 2.27 |
| TD/f | 3.72 | \|R2/R4\| | 0.60 |
| 10 × BL/f | 2.52 | V6 | 19.5 |
| \|f1/f7\| | 0.01 | V8 | 20.3 |

### 5TH EMBODIMENT

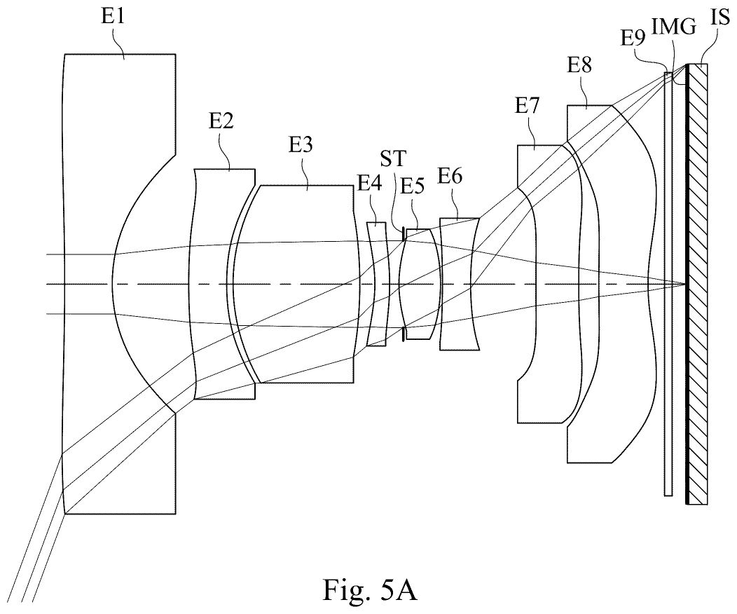

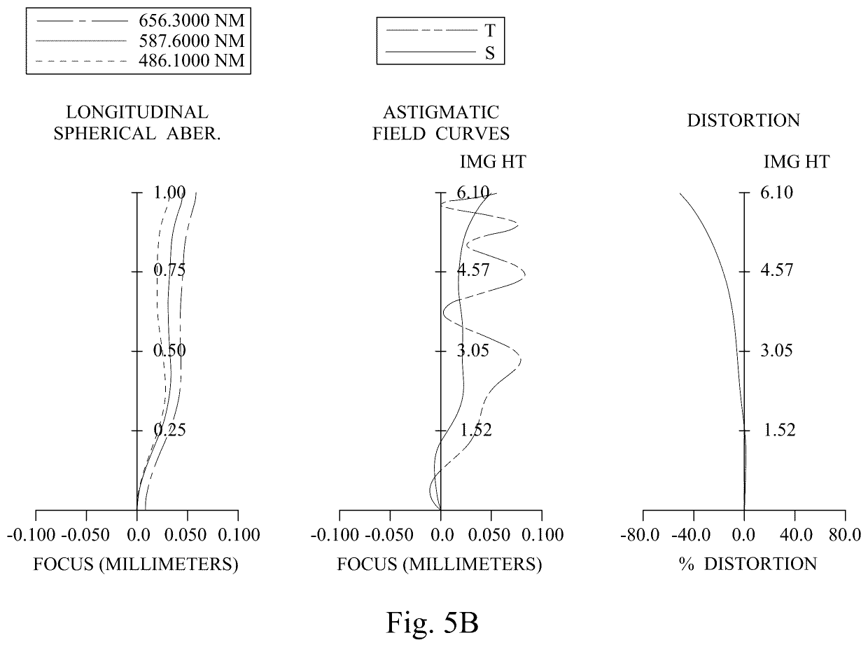

FIG. 5A is a schematic view of an imaging apparatus 5 according to the 5th embodiment of the present disclosure. FIG. 5B shows spherical aberration curves, astigmatic field curves and a distortion curve of the imaging apparatus 5 according to the 5th embodiment. In FIG. 5A, the imaging apparatus 5 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being concave in a paraxial region thereof and an image-side surface being concave in a paraxial region thereof. The first lens element E1 is made of plastic material, and has the object-side surface and the image-side surface being both aspheric. Furthermore, the object-side surface of the first lens element E1 includes one inflection point and one critical point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric.

The seventh lens element E7 with positive refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 5th embodiment are shown in Table 5A and the aspheric surface data are shown in Table 5B below.

TABLE 5A
5th Embodiment
f = 4.60 mm, Fno = 2.80, HFOV = 69.7 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | −76.3359 | ASP | 1.318 | Plastic | 1.534 | 56.0 | −7.62 |
| 2 | | 4.3279 | ASP | 2.119 | | | | |
| 3 | Lens 2 | 20.5880 | ASP | 1.052 | Plastic | 1.639 | 23.5 | −14.60 |
| 4 | | 6.2906 | ASP | 0.176 | | | | |
| 5 | Lens 3 | 5.1680 | ASP | 3.511 | Glass | 1.755 | 27.5 | 5.21 |
| 6 | | −11.6920 | ASP | 0.416 | | | | |
| 7 | Lens 4 | −4.2198 | ASP | 0.409 | Plastic | 1.669 | 19.5 | −15.48 |
| 8 | | −7.3991 | ASP | 0.378 | | | | |
| 9 | Ape. Stop | Plano | | −0.118 | | | | |
| 10 | Lens 5 | 3.4044 | ASP | 1.152 | Plastic | 1.534 | 56.0 | 3.89 |
| 11 | | −4.6931 | ASP | 0.052 | | | | |
| 12 | Lens 6 | −27.5594 | ASP | 0.779 | Plastic | 1.660 | 20.4 | −9.40 |
| 13 | | 8.1009 | ASP | 1.811 | | | | |
| 14 | Lens 7 | 45.2304 | ASP | 1.187 | Plastic | 1.551 | 44.5 | 1444.84 |
| 15 | | 47.5050 | ASP | 0.555 | | | | |
| 16 | Lens 8 | 39.8928 | ASP | 1.364 | Plastic | 1.639 | 23.5 | −13.84 |
| 17 | | 7.1375 | ASP | 0.457 | | | | |

| | | | | | | | |
|---|---|---|---|---|---|---|---|
| 18 | Filter | Plano | 0.210 | Glass | 1.517 | 64.2 | — |
| 19 | | Plano | 0.419 | | | | |
| 20 | Image | Plano | — | | | | |

Reference wavelength is 587.6 nm (d-line).

TABLE 5B
Aspheric Coefficients

| Surface # | 1 | 2 | 3 | 4 |
|---|---|---|---|---|
| k= | −9.90000E+01 | −2.91177E−01 | 2.69402E+01 | −3.86479E+00 |
| A4= | −4.949466807E−05 | −1.801432645E−03 | 2.884251449E−03 | 7.247776470E−03 |
| A6= | 5.915744487E−05 | 2.270415287E−03 | 1.261676714E−03 | 2.723714188E−03 |
| A8= | −9.284748409E−06 | −9.571592629E−04 | −8.936608621E−04 | −2.259634317E−03 |
| A10= | 8.320532669E−07 | 2.317007675E−04 | 2.133746971E−04 | 7.976465625E−04 |
| A12= | −4.531572663E−08 | −2.772297008E−05 | −2.624897451E−05 | −1.628404788E−04 |
| A14= | 1.547353033E−09 | −8.050339789E−07 | 1.322790196E−06 | 1.866442290E−05 |
| A16= | −3.326843373E−11 | 7.988398422E−07 | 3.316545985E−08 | −1.004909946E−06 |
| A18= | 4.373449604E−13 | −1.212264550E−07 | −6.273288936E−09 | 5.164838814E−09 |
| A20= | −3.209388029E−15 | 9.122033776E−09 | 1.874319675E−10 | 1.161453423E−09 |
| A22= | 1.005843935E−17 | −3.542363145E−10 | | |
| A24= | | 5.674094593E−12 | | |

| Surface # | 5 | 6 | 7 | 8 |
|---|---|---|---|---|
| k= | −1.26478E−01 | 4.70098E−01 | −1.16696E+01 | −1.78337E+01 |
| A4= | 2.137689955E−04 | 1.046459165E−03 | 6.571060569E−03 | 1.376511707E−03 |
| A6= | −6.131671658E−05 | −4.599542115E−04 | −3.871263805E−03 | 7.075067380E−05 |
| A8= | −8.298402776E−07 | −2.269928551E−05 | 1.468355293E−03 | 6.702088593E−04 |
| A10= | −5.119569056E−07 | 2.835468304E−05 | −1.428560319E−04 | −9.801121096E−06 |
| A12= | 1.078649772E−07 | −2.990362453E−06 | | |

| Surface # | 10 | 11 | 12 | 13 |
|---|---|---|---|---|
| k= | −6.47180E+00 | −6.71578E−01 | 8.11544E+01 | −9.68995E+01 |
| A4= | −1.324256860E−03 | −4.887675361E−03 | −7.844466721E−03 | 2.384071627E−02 |
| A6= | 3.153433458E−03 | −9.823232994E−03 | 1.102132177E−02 | −2.010006375E−02 |
| A8= | −2.999936050E−03 | 2.610177949E−02 | −1.323190921E−02 | 2.145756649E−02 |
| A10= | 1.945738551E−03 | −3.739377303E−02 | 1.118959291E−02 | −1.576458181E−02 |
| A12= | −8.763341318E−04 | 2.959884484E−02 | −5.361624086E−03 | 7.540093364E−03 |
| A14= | 1.481624635E−04 | −1.239009081E−02 | 1.244930027E−03 | −2.193622510E−03 |
| A16= | | 1.820810794E−03 | −1.089629971E−04 | 3.473672812E−04 |
| A18= | | 4.123753763E−04 | | −2.281622595E−05 |
| A20= | | −1.698580032E−04 | | |
| A22= | | 1.482927952E−05 | | |

| Surface # | 14 | 15 | 16 | 17 |
|---|---|---|---|---|
| k= | 3.88481E+01 | 4.10795E+01 | 3.76845E+01 | −1.41369E+01 |
| A4= | −1.657080954E−02 | −7.100668500E−04 | 4.788035383E−03 | 3.103783078E−02 |
| A6= | 2.259648620E−02 | 7.303095326E−03 | −8.885286408E−03 | −2.567102372E−02 |
| A8= | −2.010930901E−02 | −3.924859146E−03 | 1.745396975E−03 | 9.021698995E−03 |
| A10= | 9.895583508E−03 | 9.554104935E−04 | 1.224216860E−03 | −1.905203561E−03 |
| A12= | −3.031354047E−03 | −1.333628991E−04 | −8.469713037E−04 | 2.636670612E−04 |
| A14= | 5.953054624E−04 | 1.127214679E−05 | 2.455031989E−04 | −2.462796073E−05 |
| A16= | −7.461173953E−05 | −5.691485998E−07 | −4.255468951E−05 | 1.530231637E−06 |
| A18= | 5.718242656E−06 | 1.575227671E−08 | 4.860277905E−06 | −5.746345536E−08 |
| A20= | −2.408126056E−07 | −1.834020924E−10 | −3.789955425E−07 | 7.235404748E−10 |
| A22= | 4.169571779E−09 | | 2.028080673E−08 | 4.588906851E−11 |
| A24= | | | −7.298903317E−10 | −2.887203720E−12 |
| A26= | | | 1.675386012E−11 | 7.664665603E−14 |
| A28= | | | −2.185066973E−13 | −1.047161041E−15 |
| A30= | | | 1.200251975E−15 | 6.007723836E−18 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A and Table 5B as the following values and satisfy the following conditions in Table 5C:

TABLE 5C
5th Embodiment

| | | | |
|---|---|---|---|
| f [mm] | 4.60 | \|f2/f4\| | 0.94 |
| Fno | 2.80 | \|f6/f8\| | 0.68 |
| HFOV [deg.] | 69.7 | f/f78 | −0.33 |
| FOV [deg.] | 139.4 | f123/f567 | 2.64 |
| TL/ImgH | 2.83 | Dr1rs/f | 2.04 |
| 10 × BL/ImgH | 1.78 | ΣCT/ΣAT | 2.00 |
| SL/TL | 0.46 | T12/T67 | 1.17 |
| CTmax/f | 0.76 | BL/CT3 | 0.31 |
| ImgH/f | 1.33 | Dr3r6/Dr9r12 | 2.39 |
| TD/f | 3.51 | \|R2/R4\| | 0.69 |
| 10 × BL/f | 2.36 | V6 | 20.4 |
| \|f1/f7\| | 0.01 | V8 | 23.5 |

### 6TH EMBODIMENT

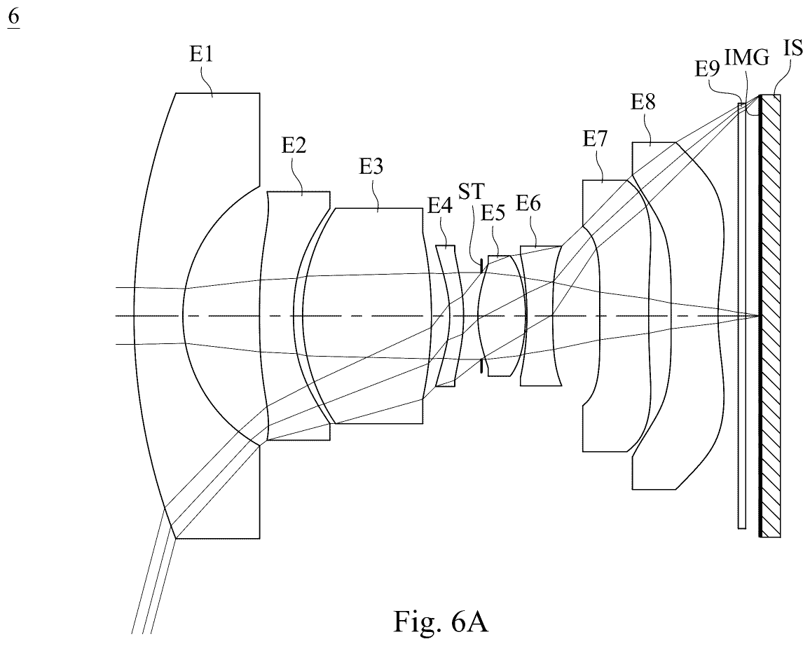

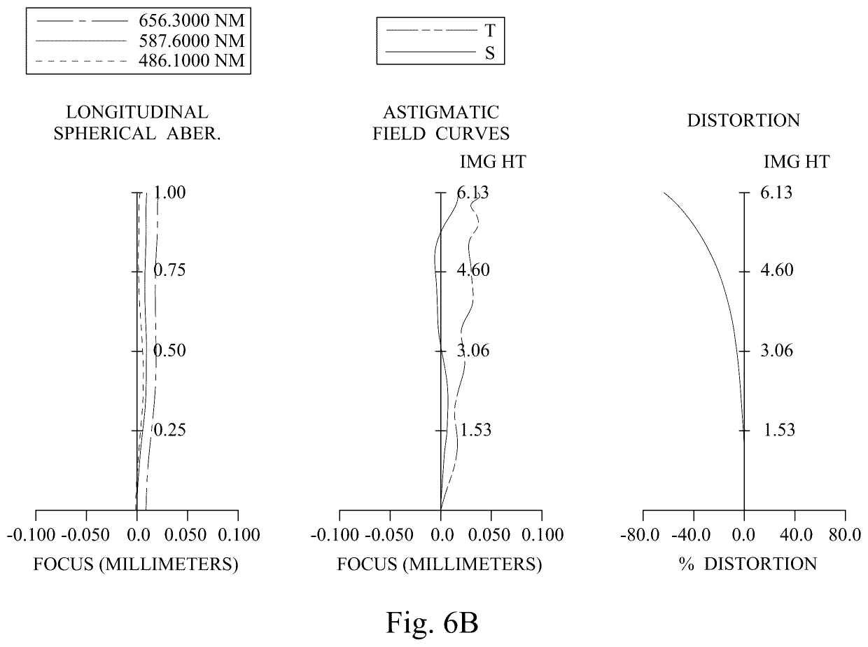

FIG. 6A is a schematic view of an imaging apparatus 6 according to the 6th embodiment of the present disclosure. FIG. 6B shows spherical aberration curves, astigmatic field curves and a distortion curve of the imaging apparatus 6 according to the 6th embodiment. In FIG. 6A, the imaging apparatus 6 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both spherical.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric. Furthermore, the image-side surface of the sixth lens element E6 includes one inflection point.

The seventh lens element E7 with negative refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being concave in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point, and the image-side surface of the eighth lens element E8 includes three inflection points and one critical point.

The filter E9 is made of glass material, which is located between the eighth lens element E8 and the image surface IMG in order, and will not affect the focal length of the imaging optical lens system.

The detailed optical data of the 6th embodiment are shown in Table 6A and the aspheric surface data are shown in Table 6B below.

TABLE 6A
6th Embodiment
f = 4.40 mm, Fno = 2.80, HFOV = 75.3 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | 16.9934 | SPH | 1.350 | Glass | 1.804 | 46.5 | −7.04 |
| 2 | | 4.0945 | SPH | 2.126 | | | | |
| 3 | Lens 2 | 25.1812 | ASP | 0.941 | Plastic | 1.660 | 20.4 | −12.38 |
| 4 | | 6.0782 | ASP | 0.251 | | | | |
| 5 | Lens 3 | 5.3378 | SPH | 3.570 | Glass | 1.805 | 25.5 | 4.97 |
| 6 | | −11.2240 | SPH | 0.508 | | | | |
| 7 | Lens 4 | −3.3581 | ASP | 0.382 | Plastic | 1.660 | 20.4 | −16.89 |
| 8 | | −5.0237 | ASP | 0.495 | | | | |
| 9 | Ape. Stop | Plano | | −0.098 | | | | |
| 10 | Lens 5 | 3.0492 | ASP | 1.320 | Plastic | 1.544 | 56.0 | 3.58 |
| 11 | | −4.5709 | ASP | 0.040 | | | | |
| 12 | Lens 6 | −8.2849 | ASP | 0.710 | Plastic | 1.660 | 20.4 | −8.44 |
| 13 | | 17.6066 | ASP | 1.305 | | | | |
| 14 | Lens 7 | 95.1552 | ASP | 1.355 | Plastic | 1.544 | 56.0 | −146.97 |
| 15 | | 43.2299 | ASP | 0.622 | | | | |
| 16 | Lens 8 | −199.9998 | ASP | 1.300 | Plastic | 1.660 | 20.4 | −11.08 |
| 17 | | 7.6059 | ASP | 0.557 | | | | |

| | | | | | | | |
|---|---|---|---|---|---|---|---|
| 18 | Filter | Plano | 0.210 | Glass | 1.517 | 64.2 | — |
| 19 | | Plano | 0.404 | | | | |
| 20 | Image | Plano | — | | | | |

Reference wavelength is 587.6 nm (d-line).

TABLE 6B
Aspheric Coefficients

| Surface # | 3 | 4 | 7 | 8 |
|---|---|---|---|---|
| k= | 3.71008E+01 | −2.95310E+00 | −7.02536E+00 | −5.22139E+00 |
| A4= | 4.812038821E−03 | 9.502294554E−03 | 2.228226842E−03 | 1.905077324E−03 |
| A6= | −4.017455692E−04 | −1.222052093E−04 | −2.202762164E−03 | −7.068397057E−04 |
| A8= | −1.149567981E−04 | −4.231248446E−04 | 7.285303197E−04 | 3.462011125E−04 |
| A10= | 5.065499705E−05 | 2.084616054E−04 | −5.077801622E−05 | 1.597663162E−05 |
| A12= | −1.163858727E−05 | −6.188120313E−05 | | |
| A14= | 1.560666369E−06 | 1.090554750E−05 | | |
| A16= | −1.235790576E−07 | −1.128007318E−06 | | |
| A18= | 5.407574518E−09 | 6.410720286E−08 | | |
| A20= | −1.011060086E−10 | −1.552132019E−09 | | |
| Surface # | 10 | 11 | 12 | 13 |
| k= | −5.18689E+00 | 6.49914E−02 | 0.00000E+00 | 0.00000E+00 |
| A4= | 3.285599852E−03 | −1.546672184E−02 | −8.097268988E−03 | 6.170454946E−03 |
| A6= | 4.831726843E−04 | 1.029488346E−02 | 1.273958362E−02 | 2.633289957E−03 |
| A8= | −1.505346174E−04 | −3.008887869E−03 | −6.794201696E−03 | 7.038864286E−05 |
| A10= | −1.122472164E−03 | −2.714300263E−03 | 1.501980701E−03 | −3.799282020E−03 |
| A12= | 7.184109038E−04 | −1.248488995E−04 | −3.314615530E−04 | 8.078330516E−03 |
| A14= | −1.741800410E−04 | 3.603389130E−03 | 1.653923808E−04 | −9.342630132E−03 |
| A16= | | −3.386309991E−03 | −3.266948145E−05 | 6.918935240E−03 |
| A18= | | 1.495862780E−03 | | −3.516298145E−03 |
| A20= | | −3.331641380E−04 | | 1.268247106E−03 |
| A22= | | 2.972703748E−05 | | −3.278809633E−04 |
| A24= | | | | 5.993063883E−05 |
| A26= | | | | −7.389831380E−06 |
| A28= | | | | 5.515095239E−07 |
| A30= | | | | −1.874217100E−08 |

| Surface # | 14 | 15 | 16 | 17 |
|---|---|---|---|---|
| k= | 0.00000E+00 | 0.00000E+00 | 0.00000E+00 | −2.03014E+01 |
| A4= | −9.785739343E−03 | 7.662820161E−03 | 7.161547338E−03 | 1.559494447E−02 |
| A6= | 9.664284133E−03 | −5.078606088E−03 | −1.730368443E−02 | −1.763003931E−02 |
| A8= | −1.511415370E−02 | 2.392219702E−03 | 1.026013702E−02 | 8.061091113E−03 |
| A10= | 1.329057373E−02 | −8.255910935E−04 | −3.696925786E−03 | −2.388104726E−03 |
| A12= | −7.658012221E−03 | 1.837683627E−04 | 8.898512435E−04 | 4.983155570E−04 |
| A14= | 2.964584939E−03 | −2.688089529E−05 | −1.472063491E−04 | −7.570813631E−05 |
| A16= | −7.755261919E−04 | 2.623717973E−06 | 1.651182637E−05 | 8.487248783E−06 |
| A18= | 1.357011336E−04 | −1.690739220E−07 | −1.182849171E−06 | −7.041540185E−07 |
| A20= | −1.539082025E−05 | 6.883365155E−09 | 4.413100455E−08 | 4.299691331E−08 |
| A22= | 1.057331980E−06 | −1.599613913E−10 | 2.436378566E−10 | −1.902698708E−09 |
| A24= | −3.810677725E−08 | 1.616646684E−12 | −1.103600822E−10 | 5.922684390E−11 |
| A26= | 4.940986884E−10 | | 5.133844309E−12 | −1.227561709E−12 |
| A28= | | | −1.052410642E−13 | 1.518766794E−14 |
| A30= | | | 8.177707037E−16 | −8.476384477E−17 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A and Table 6B as the following values and satisfy the following conditions in Table 6C:

TABLE 6C
6th Embodiment

| | | | |
|---|---|---|---|
| f [mm] | 4.40 | \|f2/f4\| | 0.73 |
| Fno | 2.80 | \|f6/f8\| | 0.76 |
| HFOV [deg.] | 75.3 | f/f78 | −0.43 |
| FOV [deg.] | 150.6 | f123/f567 | 2.92 |
| TL/ImgH | 2.83 | Dr1rs/f | 2.19 |
| 10 × BL/ImgH | 1.91 | ΣCT/ΣAT | 2.08 |
| SL/TL | 0.45 | T12/T67 | 1.63 |
| CTmax/f | 0.81 | BL/CT3 | 0.33 |
| ImgH/f | 1.39 | Dr3r6/Dr9r12 | 2.30 |
| TD/f | 3.68 | \|R2/R4\| | 0.67 |
| 10 × BL/f | 2.66 | V6 | 20.4 |
| \|f1/f7\| | 0.05 | V8 | 20.4 |

### 7TH EMBODIMENT

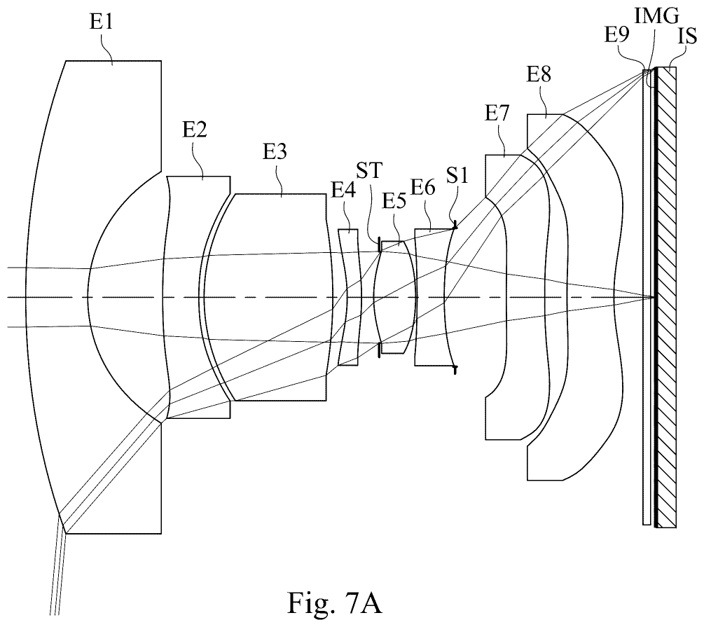

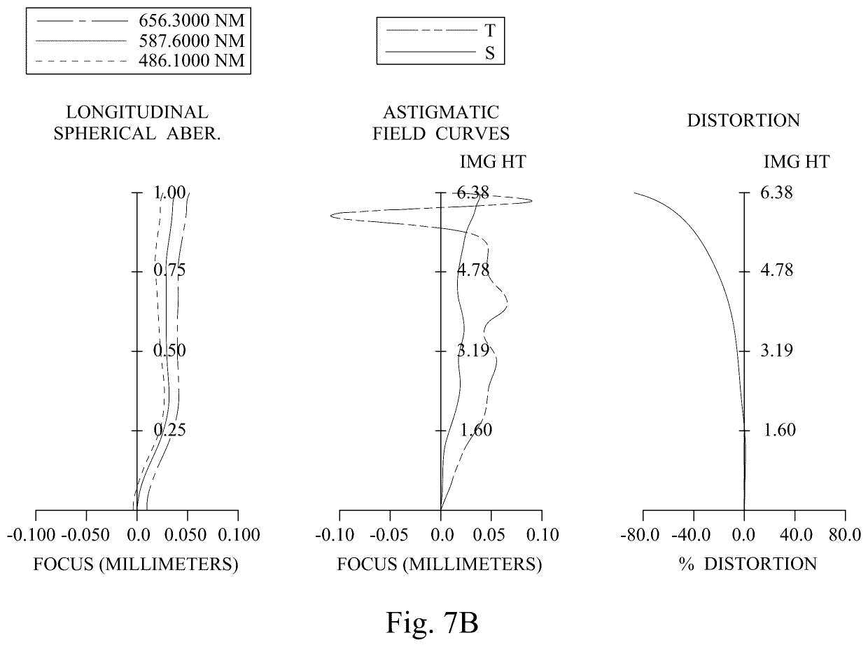

FIG. 7A is a schematic view of an imaging apparatus 7 according to the 7th embodiment of the present disclosure. FIG. 7B shows spherical aberration curves, astigmatic field curves and a distortion curve of the imaging apparatus 7 according to the 7th embodiment. In FIG. 7A, the imaging apparatus 7 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a stop S1, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both aspheric. Furthermore, the object-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric. Furthermore, the image-side surface of the third lens element E3 includes one inflection point.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point and one critical point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric.

The seventh lens element E7 with negative refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes two inflection points and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 7th embodiment are shown in Table 7A and the aspheric surface data are shown in Table 7B below.

TABLE 7A
7th Embodiment
f = 4.28 mm, Fno = 2.60, HFOV = 84.9 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | 20.8771 | ASP | 1.717 | Glass | 1.804 | 46.5 | −6.35 |
| 2 | | 3.9535 | ASP | 2.076 | | | | |
| 3 | Lens 2 | 21.1874 | ASP | 1.001 | Plastic | 1.661 | 20.3 | −14.01 |
| 4 | | 6.3214 | ASP | 0.147 | | | | |
| 5 | Lens 3 | 5.1366 | ASP | 3.565 | Glass | 1.805 | 25.5 | 4.98 |
| 6 | | −12.5806 | ASP | 0.399 | | | | |
| 7 | Lens 4 | −4.0665 | ASP | 0.396 | Plastic | 1.650 | 21.8 | −14.04 |
| 8 | | −7.6181 | ASP | 0.491 | | | | |
| 9 | Ape. Stop | Plano | | −0.153 | | | | |
| 10 | Lens 5 | 3.2205 | ASP | 1.163 | Plastic | 1.544 | 56.0 | 3.69 |
| 11 | | −4.6478 | ASP | 0.040 | | | | |
| 12 | Lens 6 | −29.3719 | ASP | 0.750 | Plastic | 1.669 | 19.5 | −10.24 |
| 13 | | 9.0244 | ASP | 0.300 | | | | |
| 14 | Stop | Plano | | 1.422 | | | | |
| 15 | Lens 7 | 45.4553 | ASP | 1.064 | Plastic | 1.567 | 37.4 | −120.39 |
| 16 | | 27.0456 | ASP | 0.616 | | | | |
| 17 | Lens 8 | 19.6078 | ASP | 1.300 | Plastic | 1.669 | 19.5 | −16.07 |
| 18 | | 6.7581 | ASP | 0.806 | | | | |

| | | | | | | | |
|---|---|---|---|---|---|---|---|
| 19 | Filter | Plano | 0.210 | Glass | 1.517 | 64.2 | — |
| 20 | | Plano | 0.151 | | | | |
| 21 | Image | Plano | — | | | | |

Reference wavelength is 587.6 nm (d-line).
Effective radius of Surface 14 (stop S1) is 1.922 mm.

TABLE 7B
Aspheric Coefficients

| Surface # | 1 | 2 | 3 | 4 |
|---|---|---|---|---|
| k= | 1.35900E+00 | −3.29420E−02 | 3.29200E+01 | −3.77180E+00 |
| A4= | −8.290265432E−05 | −7.442658987E−04 | 2.792239179E−03 | 7.626301530E−03 |
| A6= | 1.395539348E−05 | 5.137727889E−04 | 1.297930355E−03 | 2.037592254E−03 |
| A8= | −7.292050723E−07 | −9.991808009E−05 | −9.973946070E−04 | −1.904521966E−03 |
| A10= | 1.655387339E−08 | 8.695969907E−06 | 2.910082897E−04 | 7.497287062E−04 |
| A12= | −1.393625603E−10 | −2.965994228E−07 | −5.231746653E−05 | −1.832737522E−04 |
| A14= | | | 5.957113062E−06 | 2.798492658E−05 |
| A16= | | | −4.208968128E−07 | −2.573134297E−06 |
| A18= | | | 1.695826176E−08 | 1.304740404E−07 |
| A20= | | | −2.986142825E−10 | −2.800242799E−09 |

| Surface # | 5 | 6 | 7 | 8 |
|---|---|---|---|---|
| k= | −1.11894E−02 | −3.73507E−01 | −1.16267E+01 | −2.04503E+01 |
| A4= | −2.461362575E−05 | 5.401879679E−04 | 5.423412013E−03 | 1.596694343E−03 |
| A6= | 9.884452158E−05 | −2.207620681E−04 | −2.513167676E−03 | 5.511408795E−04 |
| A8= | −3.234726517E−05 | −4.661359271E−06 | 8.291808337E−04 | 1.966814066E−04 |
| A10= | 3.689664479E−06 | 5.905414398E−06 | −4.978101141E−05 | 7.392921472E−05 |
| A12= | −1.516526412E−07 | 1.183359418E−07 | | |

| Surface # | 10 | 11 | 12 | 13 |
|---|---|---|---|---|
| k= | −6.26086E+00 | 9.10885E−02 | 8.95654E+01 | −9.90000E+01 |
| A4= | 2.019392370E−04 | −1.389993096E−02 | −1.444800829E−02 | 1.946727596E−02 |
| A6= | 5.429252665E−04 | −8.649404344E−03 | 2.428088542E−02 | −9.097855085E−03 |
| A8= | 1.385469763E−03 | 7.286674801E−02 | −2.157347275E−02 | 8.137793228E−03 |
| A10= | −3.040736643E−03 | −1.510275635E−01 | 1.238428050E−02 | −5.318825184E−03 |
| A12= | 1.723815979E−03 | 1.703447106E−01 | −4.543919578E−03 | 2.329312668E−03 |
| A14= | −3.664781719E−04 | −1.187923468E−01 | 9.230594683E−04 | −6.390415441E−04 |
| A16= | | 5.232913379E−02 | −7.859001883E−05 | 9.692136323E−05 |
| A18= | | −1.418647949E−02 | | −6.127011848E−06 |
| A20= | | 2.163231963E−03 | | |
| A22= | | −1.424477494E−04 | | |

| Surface # | 15 | 16 | 17 | 18 |
|---|---|---|---|---|
| k= | 9.88818E+01 | 4.03142E+01 | −9.90000E+01 | −1.23404E+01 |
| A4= | −5.769544683E−03 | 4.309043143E−03 | 1.732762448E−03 | 2.349165186E−02 |
| A6= | 6.961369175E−03 | 2.727290991E−03 | −6.861161279E−03 | −2.201123296E−02 |
| A8= | −6.340701593E−03 | −1.961557110E−03 | 2.673279983E−03 | 9.679997598E−03 |
| A10= | 2.604155227E−03 | 4.618772768E−04 | −4.555629070E−04 | −2.885084520E−03 |
| A12= | −6.207385248E−04 | −5.736806365E−05 | 3.101201975E−05 | 6.186497259E−04 |
| A14= | 8.738940449E−05 | 3.986229480E−06 | −8.813902283E−06 | −9.657784919E−05 |
| A16= | −6.652709174E−06 | −1.449640066E−07 | 4.609892691E−06 | 1.097815989E−05 |
| A18= | 1.488924959E−07 | 2.038292588E−09 | −1.087162617E−06 | −9.067216876E−07 |
| A20= | 1.367686612E−08 | 5.196270607E−12 | 1.443548491E−07 | 5.410368294E−08 |
| A22= | −8.078343700E−10 | | −1.198292184E−08 | −2.301258008E−09 |
| A24= | | | 6.399322189E−10 | 6.790651156E−11 |
| A26= | | | −2.149040914E−11 | −1.319376895E−12 |
| A28= | | | 4.147813140E−13 | 1.516633554E−14 |
| A30= | | | −3.520085521E−15 | −7.809286179E−17 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 7A and Table 7B as the following values and satisfy the following conditions in Table 7C:

TABLE 7C
7th Embodiment

| | | | |
|---|---|---|---|
| f [mm] | 4.28 | \|f2/f4] | 1.00 |
| Fno | 2.60 | \|f6/f8\| | 0.64 |
| HFOV [deg.] | 84.9 | f/f78 | −0.30 |
| FOV [deg.] | 169.9 | f123/f567 | 3.58 |
| TL/ImgH | 2.74 | Dr1rs/f | 2.29 |
| 10 × BL/ImgH | 1.83 | ΣCT/ΣAT | 2.05 |
| SL/TL | 0.44 | T12/T67 | 1.21 |
| CTmax/f | 0.83 | BL/CT3 | 0.33 |
| ImgH/f | 1.49 | Dr3r6/Dr9r12 | 2.41 |
| TD/f | 3.81 | \|R2/R4\| | 0.63 |
| 10 × BL/f | 2.73 | V6 | 19.5 |
| \|f1/f7\| | 0.05 | V8 | 19.5 |

### 8TH EMBODIMENT

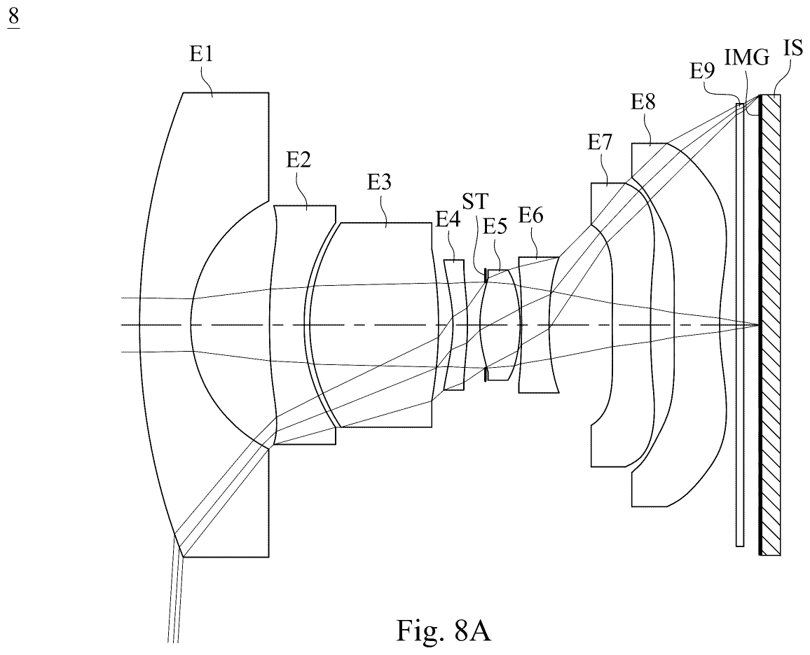

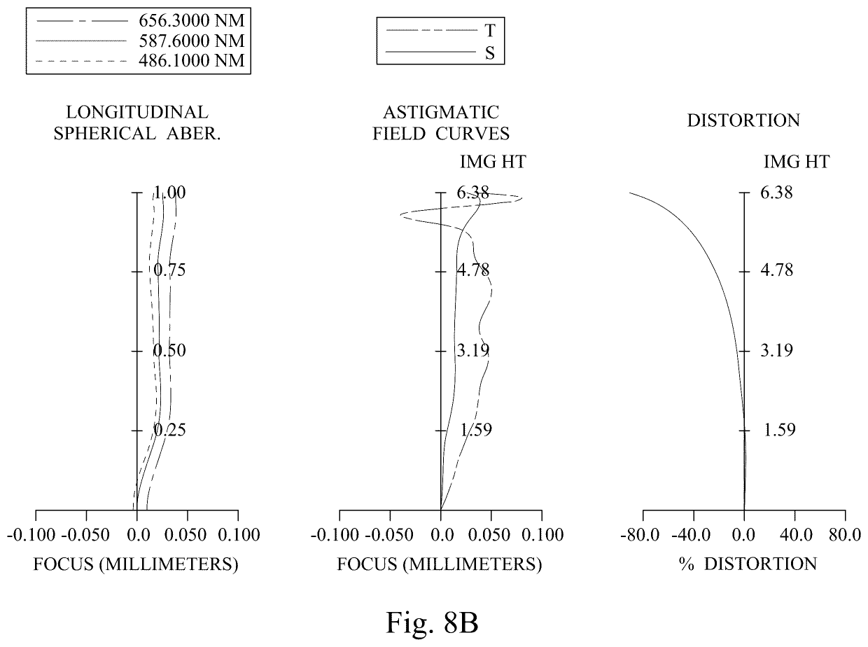

FIG. 8A is a schematic view of an imaging apparatus 8 according to the 8th embodiment of the present disclosure. FIG. 8B shows spherical aberration curves, astigmatic field curves and a distortion curve of the imaging apparatus 8 according to the 8th embodiment. In FIG. 8A, the imaging apparatus 8 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point and one critical point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric. Furthermore, the image-side surface of the sixth lens element E6 includes one inflection point.

The seventh lens element E7 with negative refractive power has an object-side surface being convex in a paraxial region thereof and an image-side surface being concave in a paraxial region thereof. The seventh lens element E7 is made of plastic material, and has the object-side surface and the image-side surface being both aspheric. Furthermore, the object-side surface of the seventh lens element E7 includes one inflection point and one critical point, and the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes two inflection points and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 8th embodiment are shown in Table 8A and the aspheric surface data are shown in Table 8B below.

TABLE 8A
8th Embodiment
f = 4.21 mm, Fno = 2.80, HFOV = 86.5 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | 18.1246 | ASP | 1.417 | Glass | 1.803 | 46.8 | −6.19 |
| 2 | | 3.7629 | ASP | 2.182 | | | | |
| 3 | Lens 2 | 21.3411 | ASP | 0.962 | Plastic | 1.661 | 20.3 | −13.32 |
| 4 | | 6.1193 | ASP | 0.153 | | | | |
| 5 | Lens 3 | 5.0747 | ASP | 3.565 | Glass | 1.805 | 25.5 | 4.85 |
| 6 | | −11.6732 | ASP | 0.400 | | | | |
| 7 | Lens 4 | −3.9699 | ASP | 0.401 | Plastic | 1.642 | 22.5 | −13.12 |
| 8 | | −7.8082 | ASP | 0.494 | | | | |
| 9 | Ape. Stop | Plano | | −0.148 | | | | |
| 10 | Lens 5 | 3.1558 | ASP | 1.114 | Plastic | 1.544 | 56.0 | 3.59 |
| 11 | | −4.4728 | ASP | 0.041 | | | | |
| 12 | Lens 6 | −24.3794 | ASP | 0.760 | Plastic | 1.669 | 19.5 | −9.63 |
| 13 | | 8.8653 | ASP | 1.752 | | | | |
| 14 | Lens 7 | 58.5488 | ASP | 1.060 | Plastic | 1.544 | 56.0 | −182.53 |
| 15 | | 36.5974 | ASP | 0.653 | | | | |
| 16 | Lens 8 | 86.1332 | ASP | 1.261 | Plastic | 1.656 | 21.3 | −15.57 |
| 17 | | 9.0812 | ASP | 0.457 | | | | |

| | | | | | | | |
|---|---|---|---|---|---|---|---|
| 18 | Filter | Plano | 0.210 | Glass | 1.517 | 64.2 | — |
| 19 | | Plano | 0.459 | | | | |
| 20 | Image | Plano | — | | | | |

Reference wavelength is 587.6 nm (d-line).

TABLE 8B
Aspheric Coefficients

| Surface # | 1 | 2 | 3 | 4 |
|---|---|---|---|---|
| k= | 1.70661E−01 | −2.89938E−02 | 3.37109E+01 | −3.62260E+00 |
| A4= | 1.855128935E−05 | −5.306235519E−04 | 3.143186626E−03 | 8.135971318E−03 |
| A6= | −1.260591274E−08 | 3.792371659E−04 | 9.090837418E−04 | 1.372403176E−03 |
| A8= | −1.726153281E−08 | −7.927765703E−05 | −8.533829669E−04 | −1.507307839E−03 |
| A10= | 5.575603402E−10 | 7.160156271E−06 | 2.652884347E−04 | 6.346801621E−04 |
| A12= | −5.574282351E−12 | −2.497855310E−07 | −5.005577752E−05 | −1.661163241E−04 |
| A14= | | | 5.861059988E−06 | 2.681601478E−05 |
| A16= | | | −4.148056819E−07 | −2.557556495E−06 |
| A18= | | | 1.624162055E−08 | 1.311106559E−07 |
| A20= | | | −2.695311051E−10 | −2.740615437E−09 |

| Surface # | 5 | 6 | 7 | 8 |
|---|---|---|---|---|
| k= | 9.03828E−03 | −1.54924E+00 | −1.11783E+01 | −2.22115E+01 |
| A4= | −2.127298510E−04 | 5.488822290E−04 | 5.310667296E−03 | 1.946138845E−03 |
| A6= | 1.589273722E−04 | −2.132271991E−04 | −2.823502429E−03 | 1.103417937E−04 |
| A8= | −3.464753314E−05 | −5.870254945E−06 | 1.097327259E−03 | 5.573211143E−04 |
| A10= | 2.768450576E−06 | 1.244799761E−05 | −1.036069848E−04 | 1.117364059E−05 |
| A12= | −6.349929192E−08 | −1.173251904E−06 | | |
| Surface # | 10 | 11 | 12 | 13 |
| k= | −5.98414E+00 | 2.83528E−01 | 8.32646E+01 | −9.90000E+01 |
| A4= | 1.253595192E−03 | −1.148138351E−02 | −1.248194568E−02 | 2.055903564E−02 |
| A6= | −2.691002986E−04 | −1.692517341E−02 | 2.095730192E−02 | −8.157770189E−03 |
| A8= | 2.312270592E−03 | 1.049545105E−01 | −1.958545983E−02 | 6.058559093E−03 |
| A10= | −4.163460868E−03 | −2.350183786E−01 | 1.253602748E−02 | −3.272195051E−03 |
| A12= | 2.454063016E−03 | 2.991791735E−01 | −5.476207357E−03 | 1.242851348E−03 |
| A14= | −5.644672232E−04 | −2.379356407E−01 | 1.353722210E−03 | −3.325326907E−04 |
| A16= | | 1.195083934E−01 | −1.387260348E−04 | 5.529789340E−05 |
| A18= | | −3.671716788E−02 | | −4.149834300E−06 |
| A20= | | 6.275192383E−03 | | |
| A22= | | −4.550086594E−04 | | |

| Surface # | 14 | 15 | 16 | 17 |
|---|---|---|---|---|
| k= | 9.90000E+01 | 8.20517E+01 | 9.90000E+01 | −1.03250E+01 |
| A4= | −4.608493312E−03 | 5.746981231E−03 | 3.071619234E−03 | 2.289021018E−02 |
| A6= | 4.578243020E−03 | 9.346960101E−04 | −8.578527232E−03 | −2.086852857E−02 |
| A8= | −5.276205152E−03 | −1.225291616E−03 | 3.838418358E−03 | 8.686216194E−03 |
| A10= | 2.723834497E−03 | 3.252036837E−04 | −8.109608761E−04 | −2.374008287E−03 |
| A12= | −8.857297501E−04 | −4.626569830E−05 | 1.341497944E−05 | 4.566413536E−04 |
| A14= | 1.902677638E−04 | 3.948862841E−06 | 3.808061014E−05 | −6.366599177E−05 |
| A16= | −2.674687990E−05 | −2.013687167E−07 | −1.120076956E−05 | 6.516553894E−06 |
| A18= | 2.328868347E−06 | 5.633395376E−09 | 1.786411533E−06 | −4.911282996E−07 |
| A20= | −1.112242650E−07 | −6.669088698E−11 | −1.857150530E−07 | 2.710269394E−08 |
| A22= | 2.131825267E−09 | | 1.312166070E−08 | −1.078181791E−09 |
| A24= | | | −6.272008841E−10 | 3.000415113E−11 |
| A26= | | | 1.946199420E−11 | −5.527385245E−13 |
| A28= | | | −3.544255328E−13 | 6.040981914E−15 |
| A30= | | | 2.878719168E−15 | −2.958652799E−17 |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 8A and Table 8B as the following values and satisfy the following conditions in Table 8C:

TABLE 8C
8th Embodiment

| | | | |
|---|---|---|---|
| f [mm] | 4.21 | \|f2/f4\| | 1.02 |
| Fno | 2.80 | \|f6/f8\| | 0.62 |
| HFOV [deg.] | 86.5 | f/f78 | −0.29 |
| FOV [deg.] | 173.1 | f123/f567 | 3.27 |
| TL/ImgH | 2.70 | Dr1rs/f | 2.27 |
| 10 × BL/ImgH | 1.77 | ΣCT/ΣAT | 1.91 |
| SL/TL | 0.44 | T12/T67 | 1.25 |
| CTmax/f | 0.85 | BL/CT3 | 0.32 |
| ImgH/f | 1.51 | Dr3r6/Dr9r12 | 2.44 |
| TD/f | 3.82 | \|R2/R4\| | 0.61 |
| 10 × BL/f | 2.67 | V6 | 19.5 |
| \|f1/f7\| | 0.03 | V8 | 21.3 |

### 9TH EMBODIMENT

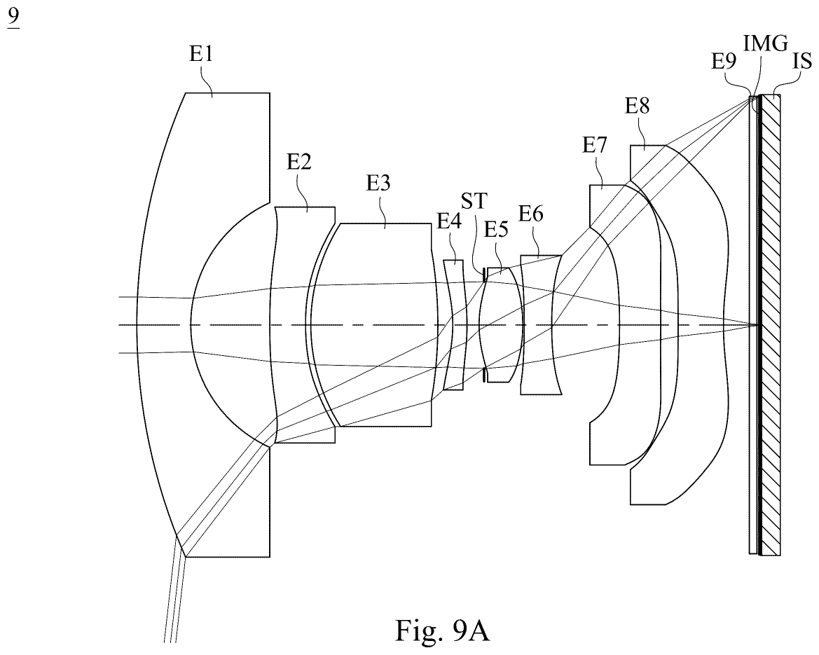

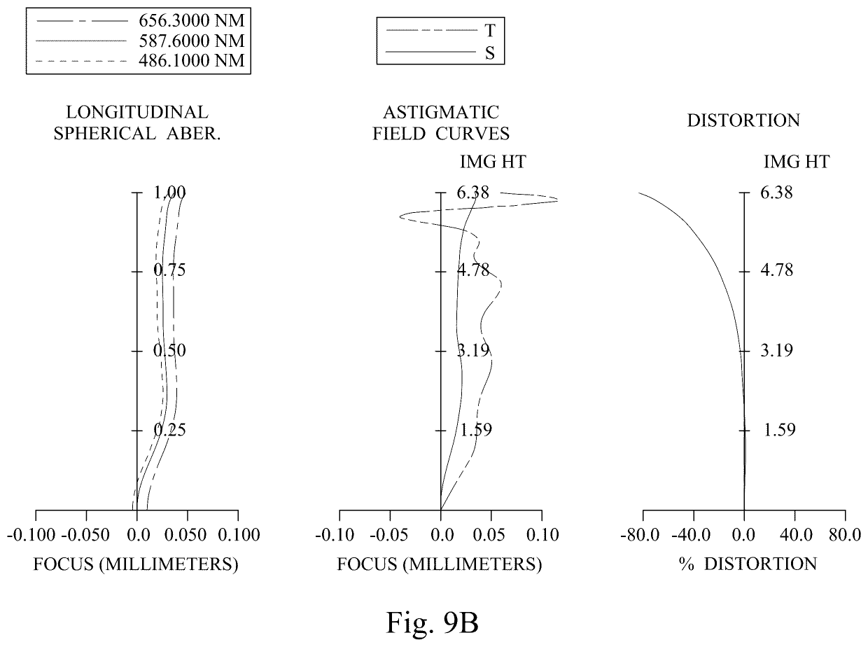

FIG. 9A is a schematic view of an imaging apparatus 9 according to the 9th embodiment of the present disclosure. FIG. 9B shows spherical aberration curves, astigmatic field curves and a distortion curve of the imaging apparatus 9 according to the 9th embodiment. In FIG. 9A, the imaging apparatus 9 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of glass material, and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both spherical.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point and one critical point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being concave in a paraxial region thereof. The sixth lens element E6 is made of plastic material, and has the object-side surface and the image-side surface being both aspheric. Furthermore, the image-side surface of the sixth lens element E6 includes one inflection point.

The seventh lens element E7 with negative refractive power has an object-side surface being concave in a paraxial region thereof and an image-side surface being convex in a paraxial region thereof. The seventh lens element E7 is made of plastic material, and has the object-side surface and the image-side surface being both aspheric. Furthermore, the image-side surface of the seventh lens element E7 includes two inflection points and two critical points.

The eighth lens element E8 with negative refractive power has an object-side surface being concave in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 9th embodiment are shown in Table 9A and the aspheric surface data are shown in Table 9B below.

TABLE 9A
9th Embodiment
f = 4.35 mm, Fno = 2.80, HFOV = 83.5 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | 15.9723 | SPH | 1.492 | Glass | 1.794 | 45.4 | −6.45 |
| 2 | | 3.7200 | SPH | 2.191 | | | | |
| 3 | Lens 2 | 21.2817 | ASP | 0.992 | Plastic | 1.669 | 19.5 | −14.21 |
| 4 | | 6.4477 | ASP | 0.142 | | | | |
| 5 | Lens 3 | 5.2103 | SPH | 3.521 | Glass | 1.805 | 25.5 | 5.01 |
| 6 | | −12.4431 | SPH | 0.413 | | | | |
| 7 | Lens 4 | −3.8585 | ASP | 0.394 | Plastic | 1.639 | 23.5 | −14.03 |
| 8 | | −7.0463 | ASP | 0.475 | | | | |
| 9 | Ape. Stop | Plano | | −0.139 | | | | |
| 10 | Lens 5 | 3.1567 | ASP | 1.211 | Plastic | 1.544 | 56.0 | 3.55 |
| 11 | | −4.2973 | ASP | 0.040 | | | | |
| 12 | Lens 6 | −21.6676 | ASP | 0.760 | Plastic | 1.669 | 19.5 | −9.93 |
| 13 | | 9.7125 | ASP | 1.880 | | | | |
| 14 | Lens 7 | −18.6068 | ASP | 1.139 | Plastic | 1.551 | 44.5 | −43.52 |
| 15 | | −84.5895 | ASP | 0.483 | | | | |
| 16 | Lens 8 | −108.6782 | ASP | 1.258 | Plastic | 1.680 | 18.2 | −15.94 |
| 17 | | 12.0944 | ASP | 0.715 | | | | |

| | | | | | | | |
|---|---|---|---|---|---|---|---|
| 18 | Filter | Plano | 0.210 | Glass | 1.517 | 64.2 | — |
| 19 | | Plano | 0.090 | | | | |
| 20 | Image | Plano | — | | | | |

Reference wavelength is 587.6 nm (d-line).

TABLE 9B
Aspheric Coefficients

| Surface # | 3 | 4 | 7 | 8 |
|---|---|---|---|---|
| k= | 3.41026E+01 | −4.02178E+00 | −1.09941E+01 | −2.05317E+01 |
| A4= | 4.286796982E−03 | 9.622584010E−03 | 4.438383181E−03 | 1.328759819E−03 |
| A6= | −5.541713949E−04 | −9.528724442E−04 | −1.821970429E−03 | 9.668048748E−04 |
| A8= | −1.203203691E−04 | 2.317301909E−06 | 7.563008077E−04 | 1.258417749E−04 |
| A10= | 7.830345034E−05 | 9.866081356E−05 | −6.488594581E−05 | 7.978835170E−05 |
| A12= | −2.283774119E−05 | −5.397238512E−05 | | |
| A14= | 3.574956788E−06 | 1.288542282E−05 | | |
| A16= | −3.132033611E−07 | −1.590707429E−06 | | |
| A18= | 1.455110821E−08 | 1.001327566E−07 | | |
| A20= | −2.798131300E−10 | −2.534215912E−09 | | |

| Surface # | 10 | 11 | 12 | 13 |
|---|---|---|---|---|
| k= | −5.92786E+00 | 4.58240E−02 | 9.52897E+01 | −9.90000E+01 |
| A4= | 8.097854649E−04 | −1.298010884E−02 | −1.291429231E−02 | 1.710470489E−02 |
| A6= | 7.293347761E−04 | −1.503434938E−02 | 2.014416584E−02 | −5.119228383E−03 |
| A8= | 1.599423682E−03 | 9.463084061E−02 | −1.532208200E−02 | 4.107518341E−03 |
| A10= | −3.873410864E−03 | −1.992301020E−01 | 6.689775905E−03 | −2.445532580E−03 |
| A12= | 2.414104408E−03 | 2.375646222E−01 | −1.874318499E−03 | 9.681754809E−04 |
| A14= | −5.623920465E−04 | −1.782917511E−01 | 3.124405485E−04 | −2.509512757E−04 |
| A16= | | 8.528844326E−02 | −2.424309238E−05 | 3.836684610E−05 |
| A18= | | −2.517444109E−02 | | −2.598184902E−06 |
| A20= | | 4.169046021E−03 | | |
| A22= | | −2.959163729E−04 | | |

| Surface # | 14 | 15 | 16 | 17 |
|---|---|---|---|---|
| k= | 7.54679E+00 | −9.90000E+01 | 9.90000E+01 | −7.73743E+00 |
| A4= | −9.239328941E−03 | 1.835731282E−03 | 1.215159508E−02 | 3.106490682E−02 |
| A6= | 8.367376605E−03 | 1.075369627E−03 | −2.505080114E−02 | −2.995202003E−02 |
| A8= | −6.755890993E−03 | −2.546694291E−04 | 1.790615363E−02 | 1.352028992E−02 |
| A10= | 2.857829068E−03 | −7.993497496E−05 | −8.446705196E−03 | −3.948787141E−03 |
| A12= | −7.532988505E−04 | 3.315825592E−05 | 2.821364544E−03 | 7.969052770E−04 |
| A14= | 1.244474444E−04 | −4.928580342E−06 | −6.796680779E−04 | −1.147182854E−04 |
| A16= | −1.210285719E−05 | 3.778804067E−07 | 1.185885914E−04 | 1.198793497E−05 |
| A18= | 5.370578161E−07 | −1.492737970E−08 | −1.500461154E−05 | −9.164040998E−07 |
| A20= | 5.175755246E−09 | 2.400848223E−10 | 1.372701823E−06 | 5.115444114E−08 |
| A22= | −1.003241378E−09 | | −8.976823275E−08 | −2.058414747E−09 |
| A24= | | | 4.088418360E−09 | 5.804407663E−11 |
| A26= | | | −1.231270524E−10 | −1.086610983E−12 |
| A28= | | | 2.203145699E−12 | 1.211058825E−14 |
| A30= | | | −1.772799041E−14 | −6.072393820E−17 |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from Table 9A and Table 9B as the following values and satisfy the following conditions in Table 9C:

TABLE 9C
9th Embodiment

| | | | |
|---|---|---|---|
| f [mm] | 4.35 | \|f2/f4\| | 1.01 |
| Fno | 2.80 | \|f6/f8\| | 0.62 |
| HFOV [deg.] | 83.5 | f/f78 | −0.39 |
| FOV [deg.] | 166.9 | f123/f567 | 3.46 |
| TL/ImgH | 2.71 | Dr1rs/f | 2.21 |
| 10 × BL/ImgH | 1.59 | ΣCT/ΣAT | 1.96 |
| SL/TL | 0.44 | T12/T67 | 1.17 |
| CTmax/f | 0.81 | BL/CT3 | 0.29 |
| ImgH/f | 1.47 | Dr3r6/Dr9r12 | 2.31 |
| TD/f | 3.74 | \|R2/R4\| | 0.58 |
| 10 × BL/f | 2.33 | V6 | 19.5 |
| \|f1/f7\| | 0.15 | V8 | 18.2 |

### 10TH EMBODIMENT

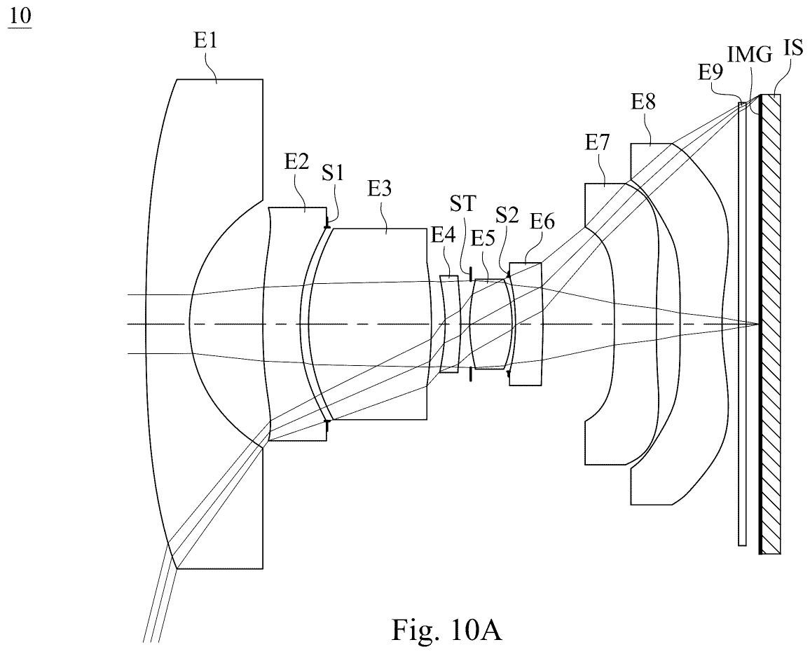

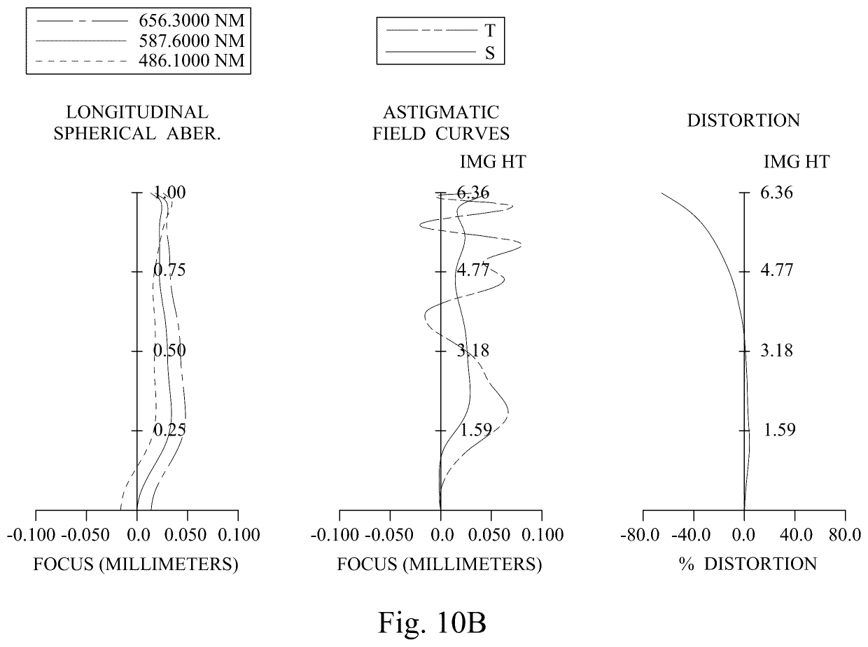

FIG. 10A is a schematic view of an imaging apparatus 10 according to the 10th embodiment of the present disclosure. FIG. 10B shows spherical aberration curves, astigmatic field curves and a distortion curve of the imaging apparatus 10 according to the 10th embodiment. In FIG. 10A, the imaging apparatus 10 includes an imaging optical lens system (its reference numeral is omitted) and an image sensor IS. The imaging optical lens system includes, in order from an object side to an image side along an optical path, a first lens element E1, a second lens element E2, a stop S1, a third lens element E3, a fourth lens element E4, an aperture stop ST, a fifth lens element E5, a stop S2, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the image-side surface of the sixth lens element E6 includes two inflection points.

The seventh lens element E7 with negative refractive power has an object-side surface being concave in a paraxial region thereof and an image-side surface being concave in a paraxial region thereof. The seventh lens element E7 is made of plastic material, and has the object-side surface and the image-side surface being both aspheric. Furthermore, the image-side surface of the seventh lens element E7 includes one inflection point and one critical point.

The eighth lens element E8 with negative refractive power has an object-side surface being concave in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes three inflection points, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 10th embodiment are shown in Table 10A and the aspheric surface data are shown in Table 10B below.

TABLE 10A
10th Embodiment
f = 4.57 mm, Fno = 2.80, HFOV = 76.0 deg.

| Surface | | | | | | | | |
|---|---|---|---|---|---|---|---|---|
| # | | Curvature Radius | | Thickness | Material | Index | Abbe # | Focal Length |
| 0 | Object | Infinity | | Infinity | | | | |
| 1 | Lens 1 | 54.1830 | ASP | 1.211 | Plastic | 1.535 | 55.9 | −7.60 |
| 2 | | 3.7503 | ASP | 2.032 | | | | |
| 3 | Lens 2 | 20.3078 | ASP | 1.032 | Plastic | 1.661 | 20.3 | −14.48 |
| 4 | | 6.3693 | ASP | 0.750 | | | | |
| 5 | Stop | Plano | | −0.516 | | | | |
| 6 | Lens 3 | 5.3246 | ASP | 3.404 | Glass | 1.755 | 27.5 | 5.29 |
| 7 | | −11.5769 | ASP | 0.380 | | | | |
| 8 | Lens 4 | −4.8515 | ASP | 0.430 | Plastic | 1.639 | 23.5 | −19.17 |
| 9 | | −8.3153 | ASP | 0.280 | | | | |
| 10 | Ape. Stop | Plano | | −0.030 | | | | |
| 11 | Lens 5 | 4.2430 | ASP | 1.174 | Plastic | 1.535 | 55.9 | 4.04 |
| 12 | | −3.9643 | ASP | −0.095 | | | | |
| 13 | Stop | Plano | | 0.190 | | | | |
| 14 | Lens 6 | −5.7829 | ASP | 0.760 | Plastic | 1.669 | 19.5 | −14.46 |
| 15 | | −15.1269 | ASP | 1.979 | | | | |
| 16 | Lens 7 | −29.0605 | ASP | 1.163 | Plastic | 1.584 | 28.2 | −37.73 |
| 17 | | 92.5926 | ASP | 0.655 | | | | |
| 18 | Lens 8 | −142.8571 | ASP | 1.163 | Plastic | 1.639 | 23.5 | −16.28 |
| 19 | | 11.2457 | ASP | 0.457 | | | | |

| | | | | | | | |
|---|---|---|---|---|---|---|---|
| 20 | Filter | Plano | 0.210 | Glass | 1.517 | 64.2 | — |
| 21 | | Plano | 0.397 | | | | |
| 23 | Image | Plano | — | | | | |

Reference wavelength is 587.6 nm (d-line).
Effective radius of Surface 5 (stop S1) is 2.681 mm.
Effective radius of Surface 13 (stop S2) is 1.313 mm.

TABLE 10B
Aspheric Coefficients

| Surface # | 1 | 2 | 3 | 4 |
|---|---|---|---|---|
| k= | 4.34642E+01 | −2.63167E−01 | 2.49852E+01 | −4.26450E+00 |
| A4= | 1.538987618E−04 | −3.113080208E−03 | 1.668261270E−03 | 6.514210351E−03 |
| A6= | 3.630935494E−06 | 2.374781926E−03 | 2.976822136E−03 | 5.067665446E−03 |
| A8= | −2.529856921E−07 | −8.039824275E−04 | −1.995955486E−03 | −4.562824815E−03 |
| A10= | 1.887666342E−08 | 1.730896668E−04 | 6.166021422E−04 | 1.990759491E−03 |
| A12= | −1.106313598E−09 | −2.458607428E−05 | −1.153628568E−04 | −5.294898338E−04 |
| A14= | 3.300528200E−11 | 2.236907607E−06 | 1.344425180E−05 | 8.726040645E−05 |
| A16= | −4.706997852E−13 | −1.159915444E−07 | −9.579584201E−07 | −8.657138247E−06 |
| A18= | 2.623785000E−15 | 2.554020091E−09 | 3.840462142E−08 | 4.724919260E−07 |
| A20= | | | −6.667806106E−10 | −1.086472439E−08 |

| Surface # | 6 | 7 | 8 | 9 |
|---|---|---|---|---|
| k= | −8.74759E−02 | −3.37657E−01 | −1.08804E+01 | −2.62530E+01 |
| A4= | −4.978576411E−05 | 3.094842465E−03 | 1.256231775E−02 | 3.927044415E−03 |
| A6= | 7.271009150E−05 | −1.850363582E−03 | −1.275009205E−02 | −6.714381773E−03 |
| A8= | −4.078005647E−05 | 2.230970248E−04 | 5.690406197E−03 | 5.676452948E−03 |
| A10= | 5.504927924E−06 | 4.977027976E−05 | −8.361600062E−04 | −9.645406797E−04 |
| A12= | −2.036739135E−07 | −1.066330279E−05 | | |

| Surface # | 11 | 12 | 14 | 15 |
|---|---|---|---|---|
| k= | −7.20159E+00 | 6.41309E−01 | 3.54518E+00 | 6.09436E+01 |
| A4= | −3.028846917E−03 | −7.435951781E−05 | 6.692195380E−04 | 1.201814146E−02 |
| A6= | 1.835464360E−03 | −8.867115464E−02 | −6.444834405E−03 | −1.063362568E−02 |
| A8= | −1.250262952E−03 | 3.676809304E−01 | 1.645059472E−02 | 1.965509425E−02 |
| A10= | 2.594868545E−03 | −9.304287903E−01 | −1.746049307E−02 | −2.001616636E−02 |
| A12= | −1.670119086E−03 | 1.520612043E+00 | 9.789228551E−03 | 1.223193668E−02 |
| A14= | 2.764245448E−04 | −1.626395493E+00 | −3.069502741E−03 | −4.395127104E−03 |
| A16= | | 1.127234145E+00 | 3.790125266E−04 | 8.477052871E−04 |
| A18= | | −4.870537448E−01 | | −6.722554439E−05 |
| A20= | | 1.190822421E−01 | | |
| A22= | | −1.257160381E−02 | | |

| Surface # | 16 | 17 | 18 | 19 |
|---|---|---|---|---|
| k= | 7.50517E+01 | −9.70695E+01 | −4.36230E+01 | −8.89264E+00 |
| A4= | −9.833408229E−03 | 5.610496860E−03 | 1.093170503E−02 | 5.096974851E−02 |
| A6= | 1.812339914E−02 | 1.861514813E−03 | −2.095402371E−02 | −4.344794282E−02 |
| A8= | −2.102258006E−02 | −1.682528386E−03 | 9.493691430E−03 | 1.671161774E−02 |
| A10= | 1.283062744E−02 | 4.285594734E−04 | −1.312853391E−03 | −3.849485416E−03 |
| A12= | −4.880455982E−03 | −5.912719171E−05 | −4.472475462E−04 | 5.702721685E−04 |
| A14= | 1.203108501E−03 | 4.901348431E−06 | 2.507449167E−04 | −5.502944570E−05 |
| A16= | −1.925092148E−04 | −2.443000596E−07 | −5.884975283E−05 | 3.262584104E−06 |
| A18= | 1.930460213E−05 | 6.741121009E−09 | 8.603024274E−06 | −8.417788210E−08 |
| A20= | −1.102815889E−06 | −7.920856928E−11 | −8.570290255E−07 | −3.274001000E−09 |
| A22= | 2.739475663E−08 | | 5.953489551E−08 | 4.085854125E−10 |
| A24= | | | −2.850782301E−09 | −1.826436678E−11 |
| A26= | | | 8.989498755E−11 | 4.514497985E−13 |
| A28= | | | −1.681525959E−12 | −6.101009812E−15 |
| A30= | | | 1.413568451E−14 | 3.536536063E−17 |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 10A and Table 10B as the following values and satisfy the following conditions in Table 10C:

TABLE 10C
10th Embodiment

| | | | |
|---|---|---|---|
| f [mm] | 4.57 | \|f2/f4\| | 0.76 |
| Fno | 2.80 | \|f6/f8\| | 0.89 |
| HFOV [deg.] | 76.0 | f/f78 | −0.42 |
| FOV [deg.] | 151.9 | f123/f567 | 2.82 |
| TL/ImgH | 2.68 | Dr1rs/f | 1.97 |
| 10 × BL/ImgH | 1.67 | ΣCT/ΣAT | 1.84 |
| SL/TL | 0.47 | T12/T67 | 1.03 |
| CTmax/f | 0.74 | BL/CT3 | 0.31 |
| ImgH/f | 1.39 | Dr3r6/Dr9r12 | 2.30 |
| TD/f | 3.49 | \|R2/R4\| | 0.59 |
| 10 × BL/f | 2.33 | V6 | 19.5 |
| \|f1/f7\| | 0.20 | V8 | 23.5 |

### 11TH EMBODIMENT

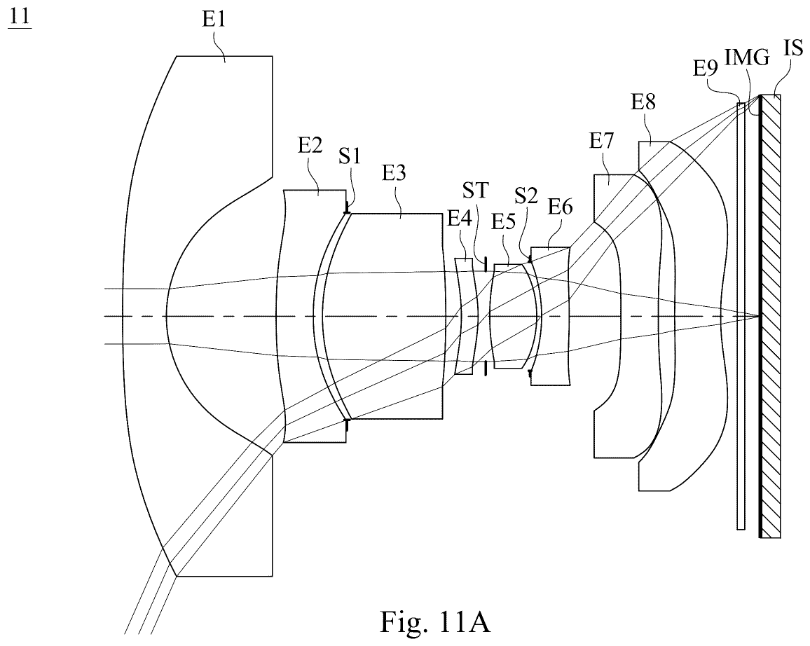

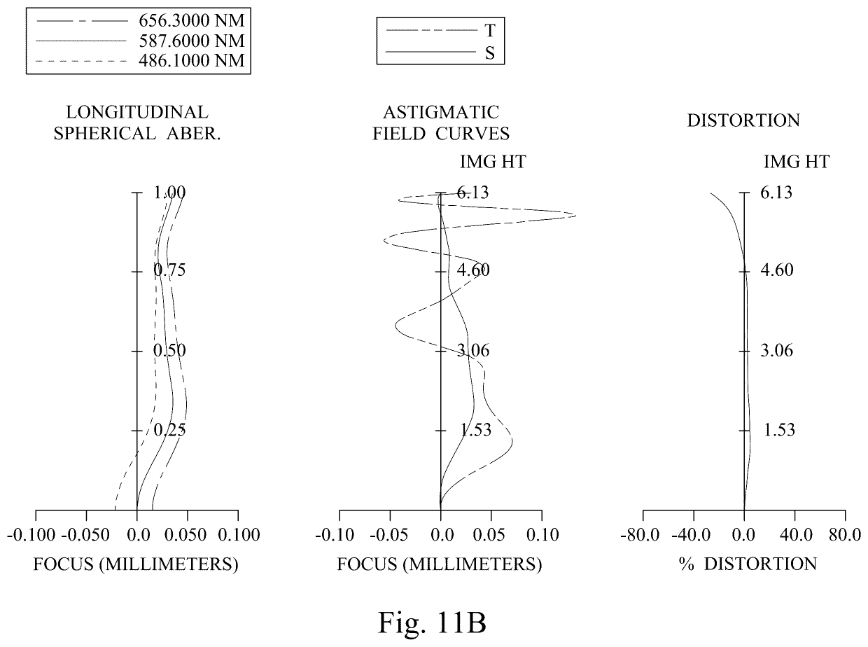

FIG. 11A is a schematic view of an imaging apparatus 11 according to the 11th embodiment of the present disclosure. FIG. 11B shows spherical aberration curves, astigmatic field curves and a distortion curve of the imaging apparatus 11 according to the 11th embodiment. In FIG. 11A, the imaging apparatus 11 includes an imaging optical lens system (its reference numeral is omitted) and an image sensor IS. The imaging optical lens system includes, in order from an object side to an image side along an optical path, a first lens element E1, a second lens element E2, a stop S1, a third lens element E3, a fourth lens element E4, an aperture stop ST, a fifth lens element E5, a stop S2, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric. Furthermore, the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric.

The fourth lens element E4 with positive refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the image-side surface of the sixth lens element E6 includes one inflection point and one critical point.

The seventh lens element E7 with negative refractive power has an object-side surface being concave in a paraxial region thereof and an image-side surface being concave in a paraxial region thereof. The seventh lens element E7 is made of plastic material, and has the object-side surface and the image-side surface being both aspheric. Furthermore, the image-side surface of the seventh lens element E7 includes one inflection point and one critical point.

The eighth lens element E8 with negative refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 11th embodiment are shown in Table 11A and the aspheric surface data are shown in Table 11B below.

TABLE 11A
11th Embodiment
f = 3.69 mm, Fno = 2.40, HFOV = 66.2 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 46.2514 | ASP | 1.212 | Plastic | 1.544 | 56.0 | −7.07 |
| 2 | | 3.5182 | ASP | 3.039 | | | | |
| 3 | Lens 2 | 18.8183 | ASP | 1.032 | Plastic | 1.669 | 19.5 | −12.92 |
| 4 | | 5.7934 | ASP | 0.930 | | | | |
| 5 | Stop | Plano | | −0.678 | | | | |
| 6 | Lens 3 | 5.0544 | ASP | 3.417 | Glass | 1.785 | 26.1 | 5.45 |
| 7 | | −19.5648 | ASP | 0.431 | | | | |
| 8 | Lens 4 | −4.9010 | ASP | 0.463 | Plastic | 1.544 | 56.0 | 36.91 |
| 9 | | −4.0706 | ASP | 0.208 | | | | |
| 10 | Ape. Stop | Plano | | 0.114 | | | | |
| 11 | Lens 5 | 6.5164 | ASP | 1.301 | Plastic | 1.544 | 56.0 | 4.09 |
| 12 | | −3.1392 | ASP | −0.184 | | | | |
| 13 | Stop | Plano | | 0.320 | | | | |
| 14 | Lens 6 | −4.2549 | ASP | 0.763 | Plastic | 1.669 | 19.5 | −8.44 |
| 15 | | −18.4863 | ASP | 1.432 | | | | |
| 16 | Lens 7 | −83.5733 | ASP | 1.038 | Plastic | 1.587 | 28.3 | −45.31 |
| 17 | | 39.2118 | ASP | 0.452 | | | | |
| 18 | Lens 8 | 34.4531 | ASP | 1.276 | Plastic | 1.614 | 25.6 | −31.03 |
| 19 | | 12.0918 | ASP | 0.457 | | | | |

| | | | | | | | |
|---|---|---|---|---|---|---|---|
| 20 | Filter | Plano | 0.210 | Glass | 1.517 | 64.2 | — |
| 21 | | Plano | 0.434 | | | | |
| 23 | Image | Plano | — | | | | |

Reference wavelength is 587.6 nm (d-line).
Effective radius of Surface 5 (stop S1) is 2.870 mm.
Effective radius of Surface 13 (stop S2) is 1.510 mm.

TABLE 11B
Aspheric Coefficients

| Surface # | 1 | 2 | 3 | 4 |
|---|---|---|---|---|
| k= | 3.20227E+01 | −3.06656E−01 | 2.32004E+01 | −4.01075E+00 |
| A4= | 6.517785463E−04 | −2.437133585E−03 | 3.297064095E−03 | 8.853358557E−03 |
| A6= | −4.987995618E−05 | 1.738824002E−03 | 3.304562630E−04 | 4.693656217E−04 |
| A8= | 5.310939651E−06 | −5.804727960E−04 | −4.225380952E−04 | −7.311632106E−04 |
| A10= | −2.927336080E−07 | 1.241802797E−04 | 1.226400458E−04 | 2.392003126E−04 |
| A12= | 8.791257939E−09 | −1.618723546E−05 | −2.156633320E−05 | −4.720729507E−05 |
| A14= | −1.495225088E−10 | 1.280260587E−06 | 2.335421801E−06 | 5.180889798E−06 |
| A16= | 1.358174726E−12 | −5.629762431E−08 | −1.537114235E−07 | −2.263785360E−07 |
| A18= | −5.129404615E−15 | 1.030279665E−09 | 5.741973365E−09 | −3.890324273E−09 |
| A20= | | | −9.462586618E−11 | 4.251248510E−10 |

| Surface # | 6 | 7 | 8 | 9 |
|---|---|---|---|---|
| k= | −3.23137E−01 | −2.60641E+01 | −1.30741E+01 | −2.14722E+01 |
| A4= | −1.750248831E−04 | 2.167978947E−03 | 8.277438460E−03 | −4.420358319E−03 |
| A6= | 1.510457027E−04 | −4.850994304E−04 | −4.401412025E−03 | 3.709271433E−03 |
| A8= | −6.659374278E−05 | −8.332671979E−05 | 1.506705967E−03 | −3.723738579E−04 |
| A10= | 7.347678958E−06 | −5.244431420E−08 | −1.588752978E−04 | 1.677426257E−04 |
| A12= | −2.706969854E−07 | 3.516541180E−06 | | |

| Surface # | 11 | 12 | 14 | 15 |
|---|---|---|---|---|
| k= | 1.68056E+00 | 4.07437E−01 | 1.42642E+00 | 4.12208E+01 |
| A4= | 1.332058460E−02 | −7.215084781E−03 | −1.125589592E−02 | 4.779050428E−03 |
| A6= | −1.517056762E−02 | −5.337065816E−02 | 1.165395720E−02 | 3.075704816E−03 |
| A8= | 1.194879273E−02 | 1.910726715E−01 | 3.546707334E−03 | −4.371196597E−04 |
| A10= | −8.269897371E−03 | −3.501545459E−01 | −8.309618741E−03 | 3.721201090E−04 |
| A12= | 3.235005510E−03 | 4.000591371E−01 | 4.281046505E−03 | −4.169520484E−04 |
| A14= | −6.548065346E−04 | −2.981649756E−01 | −1.091891078E−03 | 1.725678718E−04 |
| A16= | | 1.440680196E−01 | 1.182499883E−04 | −3.147705892E−05 |
| A18= | | −4.341450885E−02 | | 2.177638912E−06 |
| A20= | | 7.400993976E−03 | | |
| A22= | | −5.442976848E−04 | | |

| Surface # | 16 | 17 | 18 | 19 |
|---|---|---|---|---|
| k= | −9.90000E+01 | 8.63058E+00 | 4.39004E+01 | −6.94266E+00 |
| A4= | −1.566817817E−02 | 3.329712078E−03 | 1.795382945E−02 | 6.810689366E−02 |
| A6= | 2.293452590E−02 | 2.029109077E−03 | −3.439242477E−02 | −6.381752288E−02 |
| A8= | −2.342958451E−02 | −1.042113554E−03 | 2.213313433E−02 | 3.024562399E−02 |
| A10= | 1.343435318E−02 | 1.283166543E−04 | −8.442087913E−03 | −9.309488221E−03 |
| A12= | −4.974999760E−03 | 2.679647938E−06 | 2.170547383E−03 | 1.991998228E−03 |
| A14= | 1.216724358E−03 | −2.049592937E−06 | −4.028115132E−04 | −3.056648816E−04 |
| A16= | −1.939818918E−04 | 1.986558820E−07 | 5.551178597E−05 | 3.412656235E−05 |
| A18= | 1.922388782E−05 | −8.287158342E−09 | −5.698733777E−06 | −2.785564181E−06 |
| A20= | −1.067371573E−06 | 1.319002219E−10 | 4.310615972E−07 | 1.656488191E−07 |
| A22= | 2.524932803E−08 | | −2.353315820E−08 | −7.081297263E−09 |
| A24= | | | 8.969844924E−10 | 2.116317690E−10 |
| A26= | | | −2.255879899E−11 | −4.192668215E−12 |
| A28= | | | 3.354668803E−13 | 4.943133918E−14 |
| A30= | | | −2.229837129E−15 | −2.623925360E−16 |

In the 11th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 11th embodiment, so an explanation in this regard will not be provided again.

Moreover, these parameters can be calculated from Table 11A and Table 11B as the following values and satisfy the following conditions in Table 11C:

TABLE 11C
11th Embodiment

| | | | |
|---|---|---|---|
| f [mm] | 3.69 | \|f2/f4\| | 0.35 |
| Fno | 2.40 | \|f6/f8\| | 0.27 |
| HFOV [deg.] | 66.2 | f/f78 | −0.21 |
| FOV [deg.] | 132.3 | f123/f567 | 2.91 |
| TL/ImgH | 2.88 | Dr1rs/f | 2.72 |
| 10 × BL/ImgH | 1.80 | ΣCT/ΣAT | 1.73 |
| SL/TL | 0.43 | T12/T67 | 2.12 |
| CTmax/f | 0.93 | BL/CT3 | 0.32 |
| ImgH/f | 1.66 | Dr3r6/Dr9r12 | 2.14 |
| TD/f | 4.49 | \|R2/R4\| | 0.61 |
| 10 × BL/f | 2.98 | V6 | 19.5 |
| \|f1/f7\| | 0.16 | V8 | 25.6 |

### 12TH EMBODIMENT

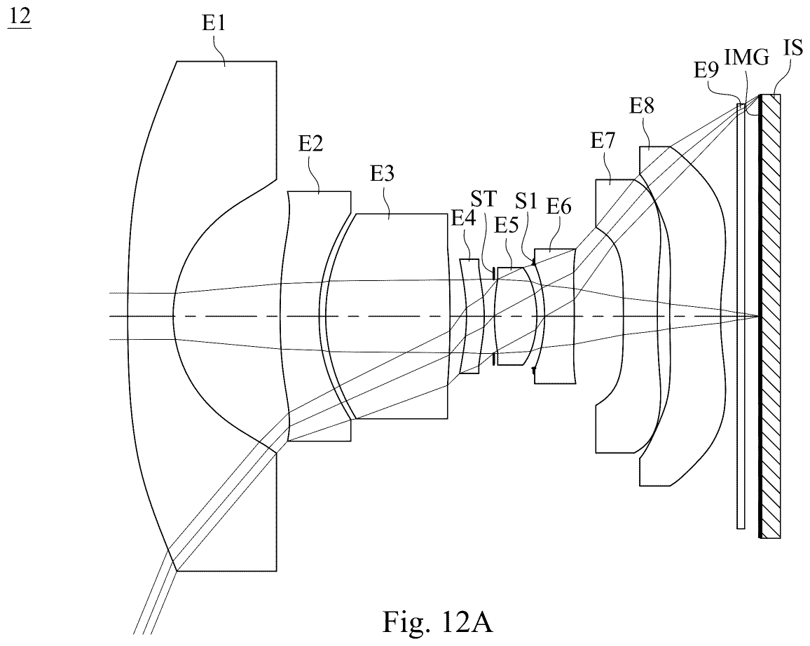

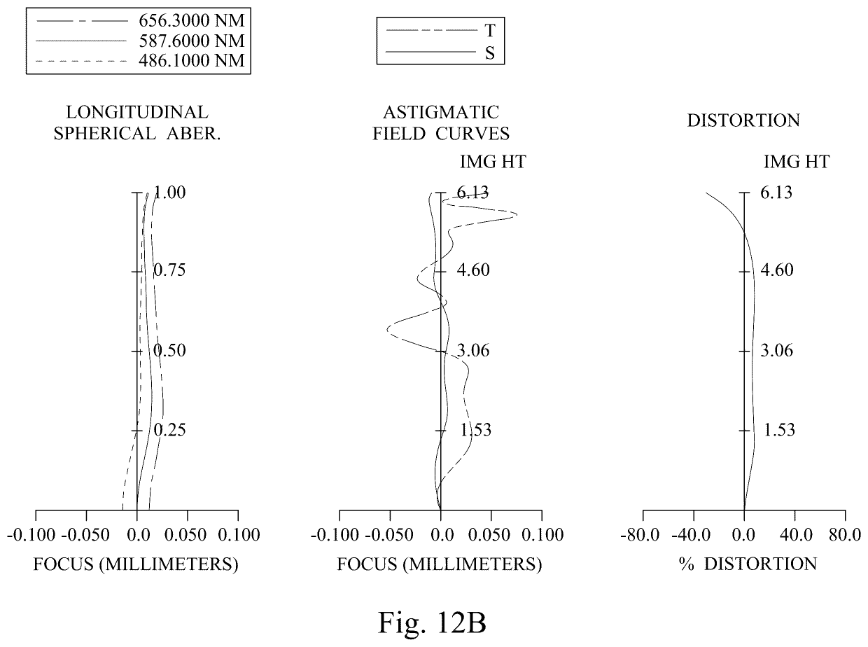

FIG. 12A is a schematic view of an imaging apparatus 12 according to the 12th embodiment of the present disclosure. FIG. 12B shows spherical aberration curves, astigmatic field curves and a distortion curve of the imaging apparatus 12 according to the 12th embodiment. In FIG. 12A, the imaging apparatus 12 includes an imaging optical lens system (its reference numeral is omitted) and an image sensor IS. The imaging optical lens system includes, in order from an object side to an image side along an optical path, a first lens element E1, a second lens element E2, a third lens element E3, a fourth lens element E4, an aperture stop ST, a fifth lens element E5, a stop S1, a sixth lens element E6, a seventh lens element E7, an eighth lens element E8, a filter E9 and an image surface IMG, wherein the image sensor IS is disposed on the image surface IMG of the imaging optical lens system. The imaging optical lens system includes eight lens elements (E1, E2, E3, E4, E5, E6, E7, E8) without additional one or more lens elements inserted between the first lens element E1 and the eighth lens element E8.

The first lens element E1 with negative refractive power has an object-side surface being convex in a paraxial region thereof and an image-side surface being concave in a paraxial region thereof. The first lens element E1 is made of plastic material, and has the object-side surface and the image-side surface being both aspheric. Furthermore, the object-side surface of the first lens element E1 includes two inflection points, and the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and one critical point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric.

The fourth lens element E4 with positive refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes two inflection points, and the image-side surface of the fourth lens element E4 includes one inflection point.

The fifth lens element E5 with positive refractive power has an object-side surface being convex in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the image-side surface of the sixth lens element E6 includes one inflection point and one critical point.

The seventh lens element E7 with negative refractive power has an object-side surface being concave in a paraxial region thereof and an image-side surface being concave in a paraxial region thereof. The seventh lens element E7 is made of plastic material, and has the object-side surface and the image-side surface being both aspheric. Furthermore, the image-side surface of the seventh lens element E7 includes one inflection point and one critical point.

The eighth lens element E8 with positive refractive power has an object-side surface being convex in a paraxial region thereof and an image-side surface being concave in a paraxial region thereof. The eighth lens element E8 is made of plastic material, and has the object-side surface and the image-side surface being both aspheric. Furthermore, the object-side surface of the eighth lens element includes one inflection point and one critical point, and the image-side surface of the eighth lens element E8 includes one inflection point and one critical point.

The filter E9 is made of glass material, which is located between the eighth lens element E8 and the image surface IMG in order, and will not affect the focal length of the imaging optical lens system.

The detailed optical data of the 12th embodiment are shown in Table 12A and the aspheric surface data are shown in Table 12B below.

TABLE 12A
12th Embodiment
f = 3.61 mm, Fno = 2.80, HFOV = 67.7 deg.

| Surface | | | | | | | | Focal |
|---|---|---|---|---|---|---|---|---|
| # | | Curvature Radius | | Thickness | Material | Index | Abbe # | Length |
| 0 | Object | Infinity | | Infinity | | | | |
| 1 | Lens 1 | 46.2763 | ASP | 1.258 | Plastic | 1.535 | 55.9 | −7.02 |
| 2 | | 3.4370 | ASP | 2.963 | | | | |
| 3 | Lens 2 | 18.8752 | ASP | 1.080 | Plastic | 1.669 | 19.5 | −13.30 |
| 4 | | 5.9083 | ASP | 0.183 | | | | |
| 5 | Lens 3 | 4.9521 | ASP | 3.443 | Glass | 1.785 | 25.8 | 5.57 |
| 6 | | −25.7629 | ASP | 0.456 | | | | |
| 7 | Lens 4 | −4.7695 | ASP | 0.491 | Plastic | 1.544 | 56.0 | 33.23 |
| 8 | | −3.9108 | ASP | 0.263 | | | | |
| 9 | Ape. Stop | Plano | | 0.019 | | | | |
| 10 | Lens 5 | 6.0434 | ASP | 1.175 | Plastic | 1.544 | 56.0 | 3.90 |
| 11 | | −3.0491 | ASP | −0.084 | | | | |
| 12 | Stop | Plano | | 0.300 | | | | |
| 13 | Lens 6 | −4.1666 | ASP | 0.820 | Plastic | 1.669 | 19.5 | −7.75 |
| 14 | | −22.9238 | ASP | 1.361 | | | | |
| 15 | Lens 7 | −50.2835 | ASP | 0.942 | Plastic | 1.587 | 28.3 | −32.29 |
| 16 | | 30.6493 | ASP | 0.342 | | | | |
| 17 | Lens 8 | 26.6171 | ASP | 1.410 | Plastic | 1.660 | 20.4 | 242.5 |
| 18 | | 31.2547 | ASP | 0.457 | | | | |

| | | | | | | | |
|---|---|---|---|---|---|---|---|
| 19 | Filter | Plano | 0.210 | Glass | 1.517 | 64.2 | — |
| 20 | | Plano | 0.430 | | | | |
| 21 | Image | Plano | — | | | | |

Reference wavelength is 587.6 nm (d-line).
Effective radius of Surface 12 (stop S1) is 1.436 mm.

TABLE 12B
Aspheric Coefficients

| Surface # | 1 | 2 | 3 | 4 |
|---|---|---|---|---|
| k= | 2.96505E+01 | −3.29105E−01 | 2.35530E+01 | −4.10280E+00 |
| A4= | 6.043566116E−04 | −4.334552880E−03 | 2.136948854E−03 | 7.868413118E−03 |
| A6= | −2.703938570E−05 | 2.705810198E−03 | 1.721602254E−03 | 1.898370144E−03 |
| A8= | 2.614236468E−06 | −8.653651808E−04 | −9.861259609E−04 | −1.528604536E−03 |
| A10= | −1.417748021E−07 | 1.857623045E−04 | 2.376286446E−04 | 4.469185318E−04 |
| A12= | 4.230510851E−09 | −2.518059573E−05 | −3.493861247E−05 | −7.047835541E−05 |
| A14= | −7.324414747E−11 | 2.062269082E−06 | 3.229028960E−06 | 4.777310858E−06 |
| A16= | 6.882461023E−13 | −9.228638134E−08 | −1.843443329E−07 | 1.570193226E−07 |
| A18= | −2.697932555E−15 | 1.701375328E−09 | 6.044178807E−09 | −4.123954381E−08 |
| A20= | | | −8.893790202E−11 | 1.648149166E−09 |

| Surface # | 5 | 6 | 7 | 8 |
|---|---|---|---|---|
| k= | −2.25821E−01 | −3.08367E+01 | −1.22087E+01 | −2.29274E+01 |
| A4= | −2.273784410E−04 | 2.367342738E−03 | 8.241935476E−03 | −5.146241114E−03 |
| A6= | 1.205792087E−04 | −5.008972253E−04 | −5.362044163E−03 | 5.563262141E−03 |
| A8= | −2.318285941E−05 | −2.440242776E−04 | 2.241820099E−03 | −7.221186457E−04 |
| A10= | −1.230585922E−06 | 6.612445815E−05 | −3.344510447E−04 | 1.681143970E−04 |
| A12= | 2.376355391E−07 | −3.434690963E−06 | | |

| Surface # | 10 | 11 | 13 | 14 |
|---|---|---|---|---|
| k= | −9.43357E−02 | 8.33614E−01 | 1.62985E+00 | 3.88908E+01 |
| A4= | 1.821508556E−02 | −7.926833548E−03 | −7.759692288E−03 | 3.886877992E−03 |
| A6= | −2.429609071E−02 | −3.831917187E−02 | 1.166597851E−02 | 2.005303524E−03 |
| A8= | 2.323030919E−02 | 1.701500985E−01 | 2.284212731E−03 | 3.107572072E−03 |
| A10= | −2.203626402E−02 | −3.937094467E−01 | −1.071436814E−02 | −3.100998434E−03 |
| A12= | 1.207291110E−02 | 5.654133800E−01 | 8.104429306E−03 | 1.422927954E−03 |
| A14= | −3.217429767E−03 | −5.304023670E−01 | −3.092663685E−03 | −3.779003631E−04 |
| A16= | | 3.239051123E−01 | 4.687087275E−04 | 5.419345514E−05 |
| A18= | | −1.242700344E−01 | | −3.182159739E−06 |
| A20= | | 2.720477384E−02 | | |
| A22= | | −2.592832682E−03 | | |

| Surface # | 15 | 16 | 17 | 18 |
|---|---|---|---|---|
| k= | −9.88375E+01 | −8.12275E+01 | 3.62678E+01 | 2.38578E+01 |
| A4= | −1.066493138E−02 | 9.314747967E−03 | 2.692292998E−02 | 1.066728335E−01 |
| A6= | 1.782100271E−02 | −4.399737408E−03 | −5.792487422E−02 | −1.057638841E−01 |
| A8= | −2.861969221E−02 | 1.691557814E−03 | 4.530380592E−02 | 5.436441896E−02 |
| A10= | 2.231514745E−02 | −5.216786372E−04 | −2.108988888E−02 | −1.792747575E−02 |
| A12= | −1.060997119E−02 | 9.632015453E−05 | 6.544451873E−03 | 4.063465420E−03 |
| A14= | 3.211899142E−03 | −1.040422523E−05 | −1.428950098E−03 | −6.556713205E−04 |
| A16= | −6.201890260E−04 | 6.504839648E−07 | 2.251093734E−04 | 7.669598980E−05 |
| A18= | 7.373775275E−05 | −2.188139787E−08 | −2.582767805E−05 | −6.551501803E−06 |
| A20= | −4.912384019E−06 | 3.066525903E−10 | 2.155440653E−06 | 4.078915708E−07 |
| A22= | 1.403728583E−07 | | −1.292745680E−07 | −1.827919610E−08 |
| A24= | | | 5.424051866E−09 | 5.736762692E−10 |
| A26= | | | −1.510781090E−10 | −1.195800835E−11 |
| A28= | | | 2.509552769E−12 | 1.486345604E−13 |
| A30= | | | −1.881915820E−14 | −8.334494032E−16 |

In the 12th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 12th embodiment, so an explanation in this regard will not be provided again.

Moreover, these parameters can be calculated from Table 12A and Table 12B as the following values and satisfy the following conditions in Table 12C:

TABLE 12C
12th Embodiment

| | | | |
|---|---|---|---|
| f [mm] | 3.61 | \|f2/f4\| | 0.40 |
| Fno | 2.80 | \|f6/f8\| | 0.03 |
| HFOV [deg.] | 67.7 | f/f78 | −0.10 |
| FOV [deg.] | 135.4 | f123/f567 | 4.18 |
| TL/ImgH | 2.86 | Dr1rs/f | 2.81 |
| 10 × BL/ImgH | 1.79 | ΣCT/ΣAT | 1.83 |
| SL/TL | 0.42 | T12/T67 | 2.18 |
| CTmax/f | 0.95 | BL/CT3 | 0.32 |
| ImgH/f | 1.70 | Dr3r6/Dr9r12 | 2.13 |
| TD/f | 4.55 | \|R2/R4\| | 0.58 |
| 10 × BL/f | 3.04 | V6 | 19.5 |
| \|f1/f7\| | 0.22 | V8 | 20.4 |

### 13TH EMBODIMENT

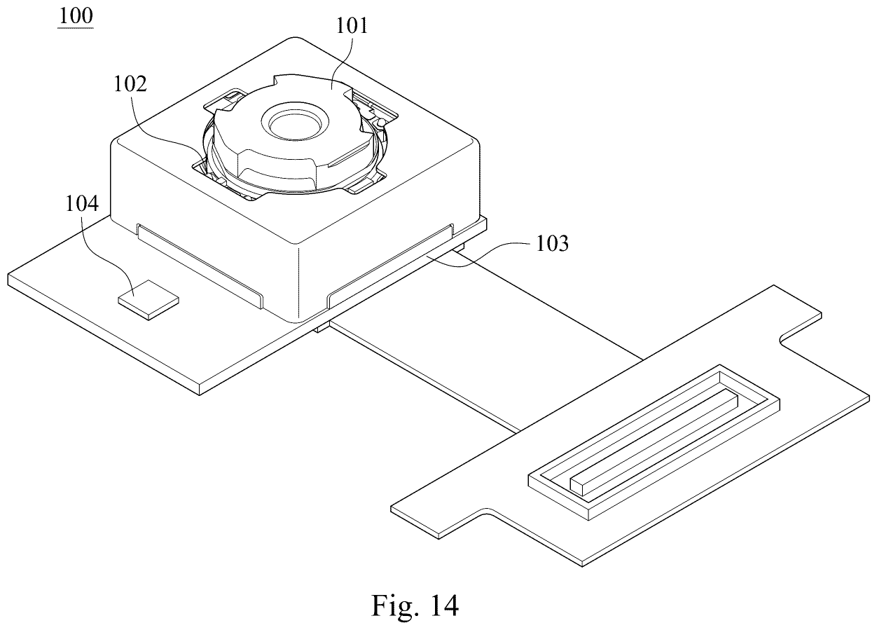

FIG. 14 is a schematic view of an imaging apparatus 100 according to the 13th embodiment of the present disclosure. In FIG. 14, the imaging apparatus 100 of the 13th embodiment is a camera module, the imaging apparatus 100 includes an imaging lens assembly 101, a driving apparatus 102 and an image sensor 103, wherein the imaging lens assembly 101 includes the imaging optical lens system of the present disclosure and a lens barrel (not shown in drawings) for carrying the imaging optical lens system. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can be an auto-focus module, which can be driven by driving systems, such as voice coil motors (VCM), micro electro-mechanical systems (MEMS), piezoelectric systems, and shape memory alloys etc. The imaging optical lens system can obtain a favorable imaging position by the driving apparatus 102 so as to capture clear images when the imaged object is disposed at different object distances.

The imaging apparatus 100 can include the image sensor 103 located on the image surface of the imaging optical lens system, such as CMOS and CCD, with superior photosensitivity and low noise. Thus, it is favorable for providing realistic images with high definition image quality thereof. Moreover, the imaging apparatus 100 can further include an image stabilization module 104, which can be a kinetic energy sensor, such as an accelerometer, a gyro sensor, and a Hall Effect sensor. In the 13th embodiment, the image stabilization module 104 is a gyro sensor, but is not limited thereto. Therefore, the variation of different axial directions of the imaging optical lens system can adjusted so as to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

### 14TH EMBODIMENT

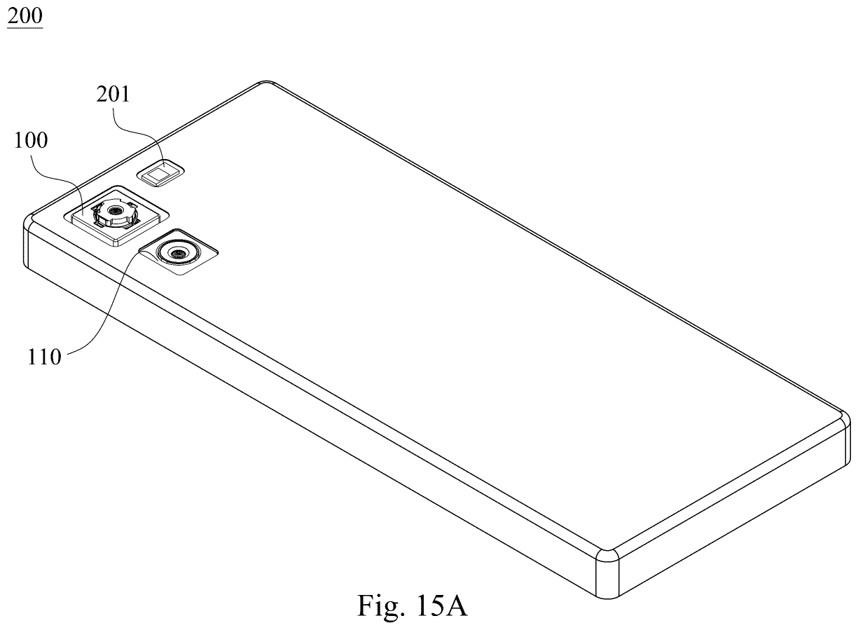

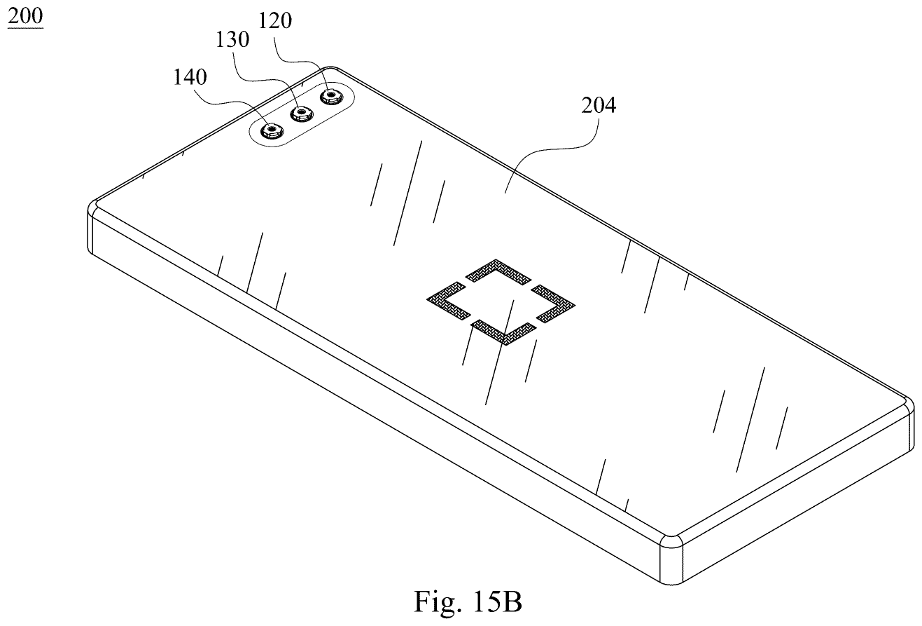

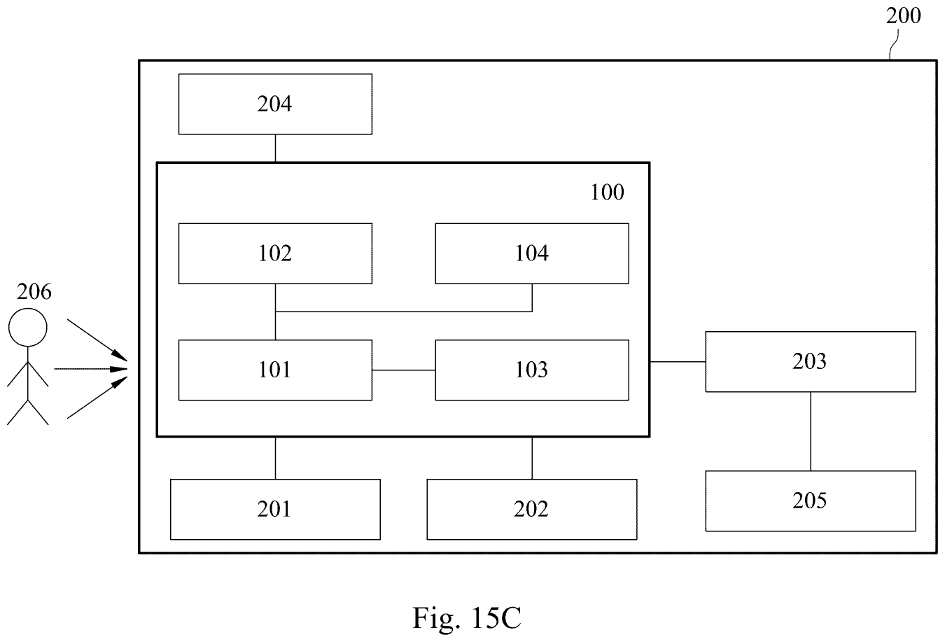

FIG. 15A is a schematic view of one side of an electronic device 200 according to the 14th embodiment of the present disclosure. FIG. 15B is a schematic view of another side of the electronic device 200 of FIG. 15A. FIG. 15C is a system schematic view of the electronic device 200 of FIG. 15A. In FIGS. 15A, 15B and 15C, the electronic device 200 according to the 14th embodiment is a smartphone, which include imaging apparatuses 100, 110, 120, 130, 140, a flash module 201, a focusing assisting module 202, an image signal processor (ISP) 203, a user interface 204 and an image software processor 205, wherein each of the imaging apparatuses 120, 130, 140 is a front camera. When the user captures images of an imaged object 206 via the user interface 204, the electronic device 200 focuses and generates an image via at least one of the imaging apparatuses 100, 110, 120, 130, 140, while compensating for low illumination via the flash module 201 when necessary. Then, the electronic device 200 quickly focuses on the imaged object 206 according to its object distance information provided by the focusing assisting module 202, and optimizes the image via the image signal processor 203 and the image software processor 205. Thus, the image quality can be further enhanced. The focusing assisting module 202 can adopt conventional infrared or laser for obtaining quick focusing, and the user interface 204 can utilize a touch screen or a physical button for capturing and processing the image with various functions of the image processing software.

Each of the imaging apparatuses 100, 110, 120, 130, 140 according to the 14th embodiment can include the imaging optical lens system of the present disclosure, and can be the same or similar to the imaging apparatus 100 according to the aforementioned 13th embodiment, and will not describe again herein. In detail, according to the 14th embodiment, the imaging apparatuses 100, 110 can be wide angle imaging apparatus and ultra-wide angle imaging apparatus, respectively, or can be wide angle imaging apparatus and telephoto imaging apparatus, respectively. The imaging apparatuses 120, 130, 140 can be wide angle imaging apparatus, ultra-wide angle imaging apparatus and TOF (Time-Of-Flight) module, respectively, or can be others imaging apparatuses, which will not be limited thereto. Further, the connecting relationships between each of the imaging apparatuses 110, 120, 130, 140 and other elements can be the same as the imaging apparatus 100 in FIG. 15C, or can be adaptively adjusted according to the type of the imaging apparatuses, which will not be shown and detailed descripted again.

### 15TH EMBODIMENT

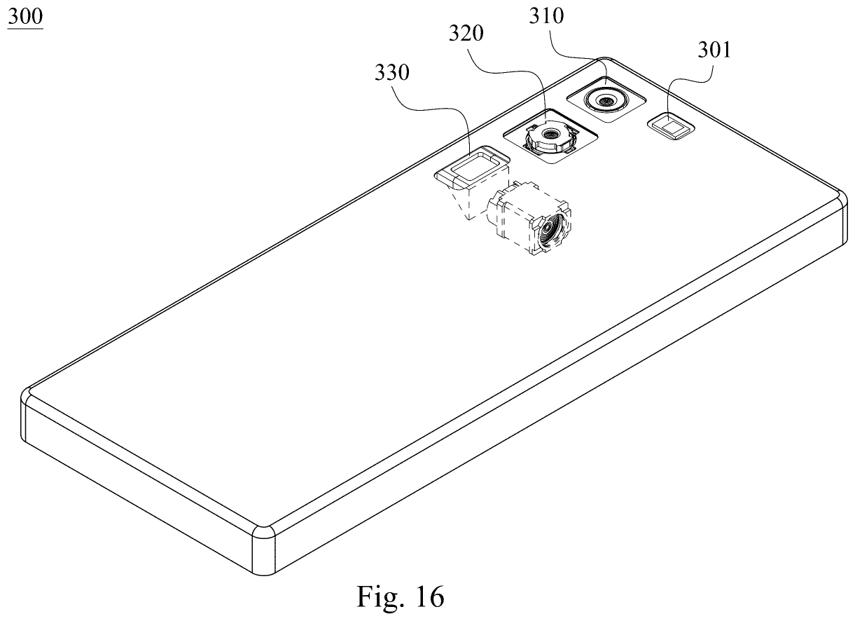

FIG. 16 is a schematic view of one side of an electronic device 300 according to the 15th embodiment of the present disclosure. According to the 15th embodiment, the electronic device 300 is a smartphone, which include imaging apparatuses 310, 320, 330 and a flash module 301.

The electronic device 300 according to the 15th embodiment can include the same or similar elements to that according to the 14th embodiment, and each of the imaging apparatuses 310, 320, 330 according to the 15th embodiment can have a configuration which is the same or similar to that according to the 14th embodiment, and will not describe again herein. In detail, according to the 15th embodiment, each of the imaging apparatuses 310, 320, 330 can include the imaging optical lens system of the present disclosure, and can be the same or similar to the imaging apparatus 100 according to the aforementioned 13th embodiment, and will not describe again herein. In detail, the imaging apparatus 310 can be ultra-wide angle imaging apparatus, the imaging apparatus 320 can be wide angle imaging apparatus, the imaging apparatus 330 can be telephoto imaging apparatus (which can include light path folding element), or can be adaptively adjusted according to the type of the imaging apparatuses, which will not be limited to the arrangement.

### 16TH EMBODIMENT

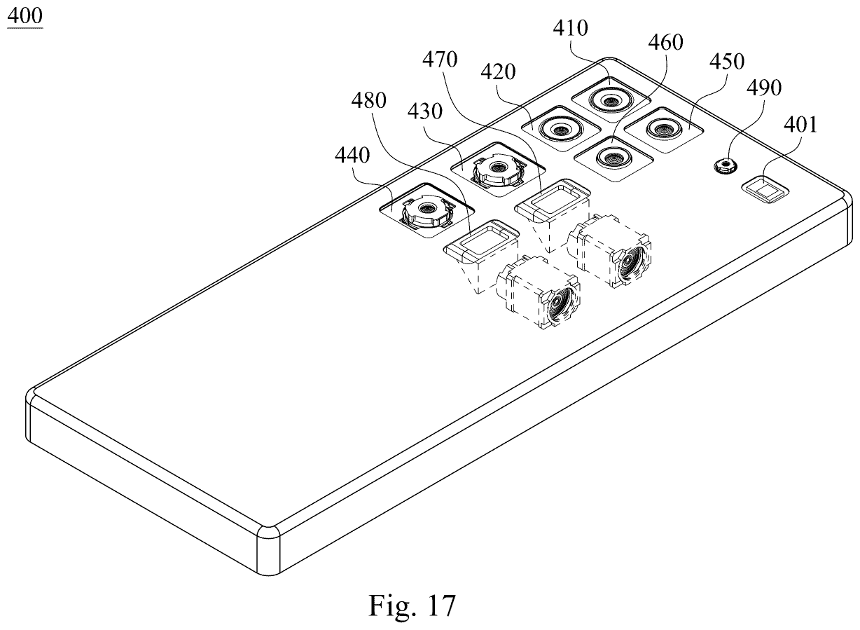

FIG. 17 is a schematic view of one side of an electronic device 400 according to the 16th embodiment of the present disclosure. According to the 16th embodiment, the electronic device 400 is a smartphone, which include imaging apparatuses 410, 420, 430, 440, 450, 460, 470, 480, 490 and a flash module 401.

The electronic device 400 according to the 16th embodiment can include the same or similar elements to that according to the 14th embodiment, and each of the imaging apparatuses 410, 420, 430, 440, 450, 460, 470, 480, 490 and the flash module 401 can have a configuration which is the same or similar to that according to the 14th embodiment, and will not describe again herein. In detail, according to the 16th embodiment, each of the imaging apparatuses 410, 420, 430, 440, 450, 460, 470, 480, 490 can include the imaging optical lens system of the present disclosure, and can be the same or similar to the imaging apparatus 100 according to the aforementioned 13th embodiment, and will not describe again herein.

In detail, each of the imaging apparatuses 410, 420 can be ultra-wide angle imaging apparatus, each of the imaging apparatuses 430, 440 can be wide angle imaging apparatus, each of the imaging apparatuses 450, 460 can be telephoto imaging apparatus, each of the imaging apparatuses 470, 480 can be telephoto imaging apparatus (which can include light path folding element), the imaging apparatus 490 can be TOF module, or can be adaptively adjusted according to the type of the imaging apparatuses, which will not be limited to the arrangement.

### 17TH EMBODIMENT

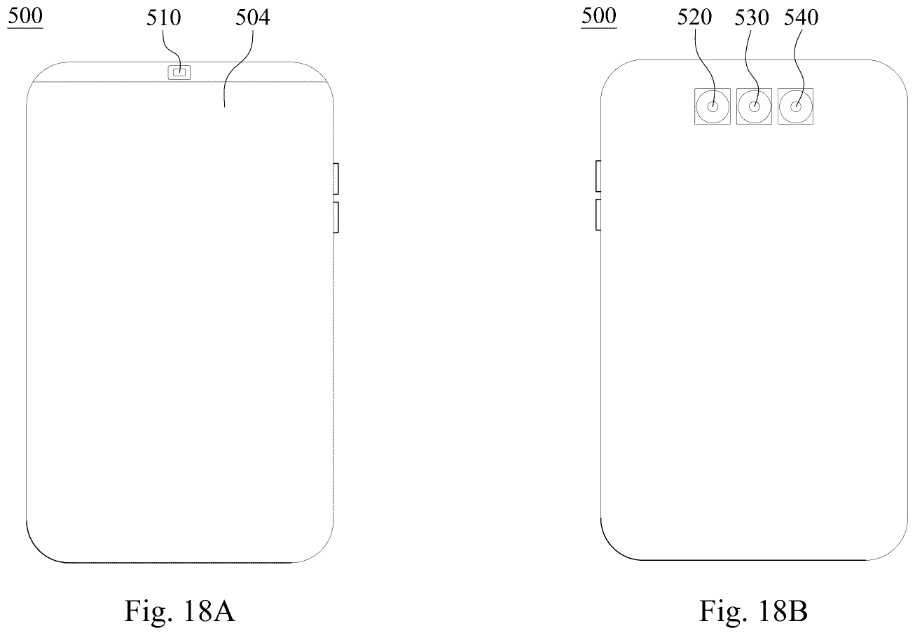

FIG. 18A is a schematic view of one side of an electronic device 500 according to the 17th embodiment of the present disclosure. FIG. 18B is a schematic view of another side of the electronic device 500 according to the 17th embodiment of FIG. 18A. In FIG. 18A and FIG. 18B, according to the 17th embodiment, the electronic device 500 is a smartphone, which include imaging apparatuses 510, 520, 530, 540 and a user interface 504.

The electronic device 500 according to the 17th embodiment can include the same or similar elements to that according to the 14th embodiment, and each of the imaging apparatuses 510, 520, 530, 540 and the user interface 504 can have a configuration which is the same or similar to that according to the 14th embodiment, and will not describe again herein. In detail, according to the 17th embodiment, the imaging apparatus 510 corresponds to a non-circular opening located on an outer side of the electronic device 500 for capturing the image, and the imaging apparatuses 520, 530, 540 can be telephoto imaging apparatus, wide angle imaging apparatus and ultra-wide angle imaging apparatus, respectively, or can be adaptively adjusted according to the type of the imaging apparatuses, which will not be limited to the arrangement.

### 18TH EMBODIMENT

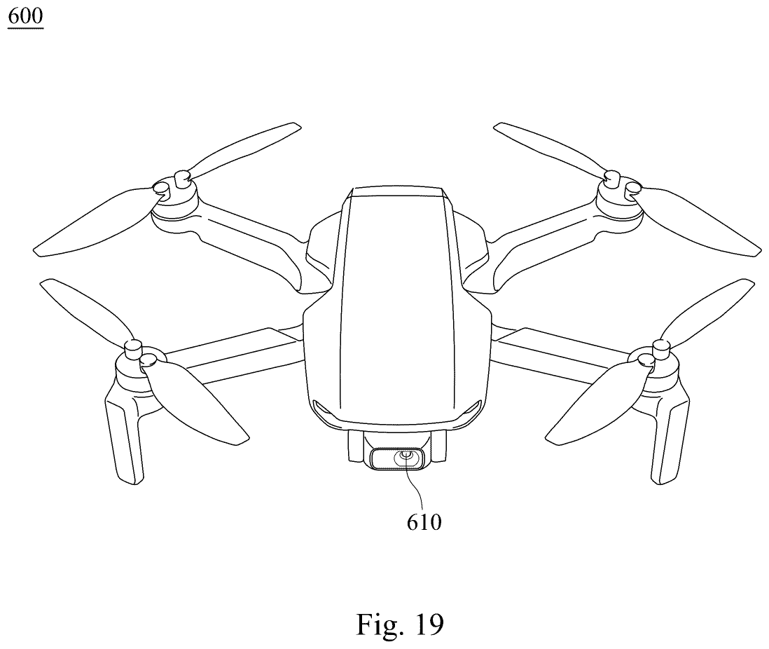

FIG. 19 is a schematic view of one side of an electronic device 600 according to the 18th embodiment of the present disclosure. In FIG. 19, according to the 18th embodiment, the electronic device 600 is an unmanned aerial vehicle, which includes an imaging apparatus 610. The imaging apparatus 610 can include the imaging optical lens system of the present disclosure, and can be the same or similar to the imaging apparatus 100 according to the aforementioned 13th embodiment, and will not describe again herein.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging optical lens system comprising eight lens elements, the eight lens elements being, in order from an object side to an image side along an optical path:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein, the first lens element has negative refractive power;
the second lens element has negative refractive power, the image-side surface of the second lens element is concave in a paraxial region thereof;
the object-side surface of the fourth lens element is concave in a paraxial region thereof;
the object-side surface of the fifth lens element is convex in a paraxial region thereof;
the sixth lens element has negative refractive power;
the image-side surface of the eighth lens element comprises at least one inflection point;
wherein a focal length of the imaging optical lens system is f, a composite focal length of the seventh lens element and the eighth lens element is f78, a curvature radius of the image-side surface of the first lens element is R2, a curvature radius of the image-side surface of the second lens element is R4, and the following conditions are satisfied:
$$- 1.20 < f / f 78 < 0.1 ; and$$
$$0.1 < \vert R 2 / R 4 \vert < 10.00 .$$

2. The imaging optical lens system of claim 1, wherein a maximum field of view of the imaging optical lens system is FOV, and the following condition is satisfied:
$$120. degrees < FOV < 190. degrees .$$

3. The imaging optical lens system of claim 1, wherein an axial distance between the image-side surface of the eighth lens element and an image surface is BL, a maximum image height of the imaging optical lens system is ImgH, and the following condition is satisfied:
$$0.5 < 10 \times BL / ImgH < 3. .$$

4. The imaging optical lens system of claim 1, further comprising:
an aperture stop, wherein an axial distance between the aperture stop and an image surface is SL, an axial distance between the object-side surface of the first lens element and the image surface is TL, and the following condition is satisfied:
$$0.3 < SL / TL < 0.55 .$$

5. The imaging optical lens system of claim 1, wherein a central thickness of the first lens element is CT1, a central thickness of the second lens element is CT2, a central thickness of the third lens element is CT3, a central thickness of the fourth lens element is CT4, a central thickness of the fifth lens element is CT5, a central thickness of the sixth lens element is CT6, a central thickness of the seventh lens element is CT7, a central thickness of the eighth lens element is CT8, a maximum among CT1, CT2, CT3, CT4, CT5, CT6, CT7, CT8 is CTmax, the focal length of the imaging optical lens system is f, and the following condition is satisfied:
$$0.4 < CT max / f < 1.20 .$$

6. The imaging optical lens system of claim 1, wherein a composite focal length of the first lens element, the second lens element and the third lens element is f123, a composite focal length of the fifth lens element, the sixth lens element and the seventh lens element is f567, and the following condition is satisfied:
$$0.6 < f 123 / f 567 < 8.00 .$$

7. The imaging optical lens system of claim 1, wherein a focal length of the sixth lens element is f6, a focal length of the eighth lens element is f8, and the following condition is satisfied:
$$0. 00 < \vert f 6 / f 8 \vert < 2. 00 .$$

8. The imaging optical lens system of claim 1, wherein an Abbe number of the eighth lens element is V8, and the following condition is satisfied:
$$5. < V 8 < 30.0 .$$

9. An imaging apparatus, comprising:
the imaging optical lens system of claim 1; and
an image sensor disposed on an image surface of the imaging optical lens system.

10. An electronic device, comprising:
the imaging apparatus of claim 9.

11. An imaging optical lens system comprising eight lens elements, the eight lens elements being, in order from an object side to an image side along an optical path:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein, the first lens element has negative refractive power;
the second lens element has negative refractive power;
the object-side surface of the fourth lens element is concave in a paraxial region thereof;
the sixth lens element has negative refractive power;
wherein a focal length of the first lens element is f1, a focal length of the seventh lens element is f7, an Abbe number of the eighth lens element is V8, and the following conditions are satisfied:
$$0. < \vert f 1 / f 7 \vert < 0.6 ; and$$
$$5. < V 8 < 30.0 .$$

12. The imaging optical lens system of claim 11, wherein the third lens element has positive refractive power; the fifth lens element has positive refractive power.

13. The imaging optical lens system of claim 11, wherein an axial distance between the object-side surface of the first lens element and an image surface is TL, a maximum image height of the imaging optical lens system is ImgH, and the following condition is satisfied:
$$2. < TL / ImgH < 4. .$$

14. The imaging optical lens system of claim 11, wherein a maximum image height of the imaging optical lens system is ImgH, a focal length of the imaging optical lens system is f, and the following condition is satisfied:
$$1. < ImgH / f < 2.00 .$$

15. The imaging optical lens system of claim 11, wherein an axial distance between the object-side surface of the first lens element and the image-side surface of the eighth lens element is TD, a focal length of the imaging optical lens system is f, and the following condition is satisfied:
$$2.5 < TD / f < 5.00 .$$

16. The imaging optical lens system of claim 11, wherein an axial distance between the image-side surface of the eighth lens element and an image surface is BL, a central thickness of the third lens element is CT3, and the following condition is satisfied:
$$0. 15 < BL / CT 3 < 0.70 .$$

17. The imaging optical lens system of claim 11, wherein an axial distance between the object-side surface of the second lens element and the image-side surface of the third lens element is Dr3r6, an axial distance between the object-side surface of the fifth lens element and the image-side surface of the sixth lens element is Dr9r12, and the following condition is satisfied:
$$1.6 < Dr 3 r 6 / Dr 9 r 12 < 3.00 .$$

18. The imaging optical lens system of claim 11, wherein an axial distance between the first lens element and the second lens element is T12, an axial distance between the sixth lens element and the seventh lens element is T67, and the following condition is satisfied:
$$0.5 < T 12 / T 67 < 4.00 .$$

19. The imaging optical lens system of claim 11, wherein a central thickness of the third lens element is a maximum among central thicknesses of the eight lens elements.

20. An imaging optical lens system comprising eight lens elements, the eight lens elements being, in order from an object side to an image side along an optical path:
a first lens element, a second lens element, a third lens element, a fourth lens element, a fifth lens element, a sixth lens element, a seventh lens element and an eighth lens element; each of the eight lens elements has an object-side surface towards the object side and an image-side surface towards the image side;
wherein, the first lens element has negative refractive power;
the second lens element has negative refractive power;
the object-side surface of the fourth lens element is concave in a paraxial region thereof;
the sixth lens element has negative refractive power;
the image-side surface of the eighth lens element comprises at least one inflection point;
wherein an axial distance between the object-side surface of the first lens element and the image-side surface of the eighth lens element is TD, a focal length of the imaging optical lens system is f, a composite focal length of the seventh lens element and the eighth lens element is f78, and the following conditions are satisfied:
$$2. < TD / f < 5. ; and$$
$$- 0.8 \; 0 < f / f 78 < 0.00 .$$

21. The imaging optical lens system of claim 20, wherein the image-side surface of the fourth lens element is convex in a paraxial region thereof; the object-side surface of the fifth lens element is convex in a paraxial region thereof.

22. The imaging optical lens system of claim 20, wherein the object-side surface of the second lens element comprises at least one inflection point.

23. The imaging optical lens system of claim 20, wherein at least one of the third lens element, the fourth lens element and the fifth lens element is made of glass material.

24. The imaging optical lens system of claim 20, wherein an axial distance between the image-side surface of the eighth lens element and an image surface is BL, the focal length of the imaging optical lens system is f, and the following condition is satisfied:
$$1.5 < 10 \times BL / f < 4.00 .$$

25. The imaging optical lens system of claim 20, wherein a focal length of the second lens element is f2, a focal length of the fourth lens element is f4, and the following condition is satisfied:
$$0. 00 < \vert f 2 / f 4 \vert < 1. 60 .$$

26. The imaging optical lens system of claim 20, wherein a sum of central thicknesses of the lens elements of the imaging optical lens system is ΣCT, a sum of all axial distances between adjacent lens elements of the imaging optical lens system is ΣAT, and the following condition is satisfied:
$$1.2 < \sum CT / \sum AT < 2.5 .$$

27. The imaging optical lens system of claim 20, further comprising:
an aperture stop, wherein an axial distance between the object-side surface of the first lens element and the aperture stop is Dr1rs, the focal length of the imaging optical lens system is f, and the following condition is satisfied:
$$1.5 < Dr 1 rs / f < 3.50 .$$

28. The imaging optical lens system of claim 20, wherein an Abbe number of the sixth lens element is V6, and the following condition is satisfied:
$$5. < V 6 < 26.0 .$$

29. The imaging optical lens system of claim 20, wherein the focal length of the imaging optical lens system is f, the composite focal length of the seventh lens element and the eighth lens element is f78, a curvature radius of the image-side surface of the first lens element is R2, a curvature radius of the image-side surface of the second lens element is R4, a focal length of the first lens element is f1, a focal length of the seventh lens element is f7, an Abbe number of the eighth lens element is V8, the axial distance between the object-side surface of the first lens element and the image-side surface of the eighth lens element is TD, and the following conditions are satisfied:
$$- 0.43 \leq f / f 78 \leq - 0.1 ;$$
$$0.53 \leq \vert R 2 / R 4 \vert \leq 0.69 ;$$
$$0.01 \leq \vert f 1 / f 7 \vert \leq 0.22 ;$$
$$18.2 \leq V 8 \leq 25.6 ; and$$
$$3.49 \leq TD / f \leq 4.55 .$$
